SEQUENCE LISTING (2 sequences)

SEQ ID NO: 1 - DNA, 10 bp, Artificial Sequence
  Description of Artificial Sequence Synthetic oligonucleotide
atttattagg

SEQ ID NO: 2 - DNA, 10 bp, Artificial Sequence
  Description of Artificial Sequence Synthetic oligonucleotide
cgggcggcaa

(19) United States
(12) Patent Application Publication
(10) Pub. No.: US 2012/0040869 A1
(43) Pub. Date: Feb. 16, 2012

(54) SEQUENCE PRESERVED DNA CONVERSION

(75) Inventors: Amit MELLER, Brookline, MA (US); Zhiping WENG, Wellesley, MA (US)

(73) Assignee: THE TRUSTEES OF BOSTON UNIVERSITY, Boston, MA (US)

(21) Appl. No.: 13/095,391

(22) Filed: Apr. 27, 2011

Related U.S. Application Data
(63) Continuation of application No. PCT/US09/62464, filed on Oct. 29, 2009.
(60) Provisional application No. 61/109,298, filed on Oct. 29, 2008.

(51) Int. Cl. C40B 50/06

(52) U.S. Cl. 506/26

(57) ABSTRACT

Described herein are inexpensive high throughput methods to convert a target single stranded DNA (ssDNA) such that each nucleotide (or base) adenine (A), thymine (T), guanine (G) and cytosine (C) is converted to a pre-determined oligonucleotide code, with the sequential order preserved in the converted ssDNA, or RNA. The method does not require the use of DNA polymerases during the cycles and involves the use of an oligonucleotide probe library with repeated cycles of ligation and cleavage. At each cycle, one or more nucleotides on one end (e.g., either the 5′ end or the 3′ end) of a target, e.g., ssDNA, are cleaved and then ligated with the corresponding oligonucleotide code at the other end of the target ssDNA.

### CROSS REFERENCE TO RELATED APPLICATIONS

This application is a Continuation of International Application PCT/US09/62464, filed Oct. 29, 2009, which claims the benefit of priority to U.S. Provisional Application No. 61/109,298, filed Oct. 29, 2008, the entire disclosures of which are incorporated by reference herein.

### FIELD OF THE INVENTION

The present invention relates to a method for conversion of a target nucleic acid molecule according to a predetermined nucleotide code. The converted nucleic acid can subsequently be used for determining the nucleotide sequence of the target molecule.

### BACKGROUND

The pioneering completion of the 1st reference human genome sequence (International Human Genome Sequencing Consortium Nature 2001; 490:860-921; Venter J C, Adams M D, Myers E W, Li P W, Mural R J, Sutton G G, et al. Science 2001; 291:1304-51) has marked the commencement of an era in which genomic variations directly impact drug discovery and medical therapy. This new paradigm has created a need for inexpensive and ultra-fast methods for DNA sequencing. It is thought that in the near future, medical practitioners will be able to routinely analyze the DNA of individual patients in a clinical setting before prescribing drugs. Sequence information obtained from the individual could be checked against online databases in which genomic information relevant to any drug is documented.

In addition, affordable sequencing technologies will transform research in comparative genomics and molecular biology, allowing scientists to quickly sequence whole genomes from cell variants. To realize ultra-fast and inexpensive DNA sequencing, revolutionary technologies are needed to replace the classical methods based on Sanger's “dideoxy” protocol (Shendure J, Mitra R D, Varma C, Church G M. Nat Rev Genet 2004; 5:335-44). Modern sequencing based on the Sanger method typically produces a sequence that has poor quality in the first 15-40 bases, a high quality region of no more than 700-900 bases, and then quickly deteriorating quality for the remainder of the sequence.

New sequencing technologies need to address two major issues. First, sample size should be reduced to a minimum, enabling sequence readout from a single DNA molecule or a small number of copies. Second, readout speed should be increased by several orders of magnitude compared to current state-of-the-art techniques. In recent years, nanopores have been used extensively as sensitive single-biomolecule detectors. It has been shown that single-stranded DNA molecules can be electrophoretically driven through a 1.5-nm α-hemolysin nanopore in a single file manner. This process is termed DNA translocation (Kasianowicz J, Brandin E, Branton D, Deamer D. Proc Natl Acad Sci USA 1996; 93:13770-3; Akeson M, Branton D, Kasianowicz J, Brandin E, Deamer D. Biophys J 1999; 77:3227-33; Meller A, Nivon L, Brandin E, Golovchenko J, Branton D. Proc Natl Acad Sci USA 2000; 97:1079-84). One of the driving ideas in this field has been that nanopores could be used for direct electronic readout of the DNA sequence (Deamer D W, Akeson M. Tibtech 2000; 18:147-50.). Early studies, however, have indicated that several prominent issues must be addressed before nanopores can be used for single-molecule sequencing (Meller A, et al (2000), supra; Meller A, Nivon L, Branton D. Phys Rev Lett 2001; 86:3435-8). In particular, fast DNA translocation speed and low contrast between the electrical signals of the 4 base types have prevented single nucleotide differentiation.

A major advantage of nanopore sequencing is that a single molecule of DNA can be probed directly using a nanopore, without the need for amplification of a DNA molecule, which is error-prone, low-throughput and costly. At present however, nanopore sequencing techniques do not have single nucleotide resolution. Although much progress has been made, the minimal number of bases that can be resolved by a nanopore has not been firmly established. Our approach has been to convert nucleic acid sequences into a longer sequence that can be converted so that the sequence is preserved. The longer sequence can then be read by a nanopore directly. Thus, the manner in which the conversion is done must be fast, highly reliable and inexpensive and there is a need to develop new methods for carrying out such conversions.

### SUMMARY OF THE INVENTION

Described herein are inexpensive high throughput methods to convert a target single stranded DNA (ssDNA) such that each nucleotide (or base) adenine (A), thymine (T), guanine (G) and cytosine (C) is converted to a pre-determined oligonucleotide code, with the sequential order preserved in the converted ssDNA. One can also adapt this method to convert RNA by appropriate modification thereof. The method involves the use of an oligonucleotide probe library with repeated cycles of ligation and cleavage. At each cycle, one or more nucleotides on one end (e.g., either the 5′ end or the 3′ end) of a target, e.g. ssDNA, are cleaved and then ligated with the corresponding oligonucleotide code at the other end of the target ssDNA. The method does not require the use of DNA polymerases during the cycles, which eliminates the introduction of errors into the sequence via a polymerase (see e.g., T. Sjoblom et al., Science 314, 268 (2006)). One embodiment of the invention permits sequencing of e.g., an entire human genome in a relatively short time (e.g., no more than a couple of days, in some embodiments no more than a day).

In one embodiment the converted nucleotides are separated by pre-determined oligonucleotide codes that can further bind to molecular beacons. The converted single stranded nucleic acid molecule (e.g., ssDNA) can thus be sequenced, in one embodiment, through the use of a nanopore, wherein one bound molecular beacon is removed at a time as the converted ssDNA strand moves through a nanopore. Removing a molecular beacon produces a flash of light, which translates to the sequence of a target single stranded nucleic acid molecule. Since the longer pre-determined oligonucleotide codes (each code corresponding to each of the nucleotides A, C, T or G in e.g., a target ssDNA) are integrated into the target ssDNA molecule, the method described herein does not require detection at the single nucleotide level and thus overcomes one of the major challenges of nanopore-based sequencing. The methods of the invention described herein permit rapid sequencing with any sequencing method useful at the single molecule level (i.e., sequencing is not limited to nanopore sequencing).

One aspect of the methods described herein relates to DNA conversion. This involves the formation of a circular molecule comprising a target single stranded DNA (ssDNA) by ligating double stranded or T-shaped probes to the target ssDNA, digesting with a Type II restriction enzyme, wherein digesting leads to the removal of a converted base from the target ssDNA while adding a longer oligonucleotide tag representing the converted nucleotide. In addition, another aspect described herein relates to the use of an oligonucleotide probe library, comprising T-shaped probes, for the purpose of converting a ssDNA molecule.

One aspect of the invention disclosed herein relates to a method for converting a target single stranded DNA (ssDNA) molecule starting at its 3′ end, such that the nucleotides adenine (A), guanine (G), cytosine (C), or thymine (T) of the target ssDNA molecule are converted to a predetermined oligonucleotide code and that the order of the nucleotides of the target ssDNA is preserved during conversion. The method comprises the steps of:

(a) contacting a target ssDNA having the pre-specified sequence 5′-x₀, S₁, S₂, S₃, S₄, S₅-3′ at its 5′-end, wherein x₀ can be A, C, G, or T and S₁, S₂, S₃, S₄, S₅ is the sequence in the first five positions of a predetermined oligonucleotide code (Xₓ), with a probe library comprising a plurality of oligonucleotide probes, wherein each probe comprises a double stranded DNA portion and a first and second single-stranded overhang, wherein the double stranded DNA portion comprises a recognition sequence of a type IIS restriction enzyme (R′/R) and the predetermined oligonucleotide code (X′ₓ/Xₓ) that uniquely corresponds to the nucleotide to be converted (x) in the target ssDNA, wherein there is a type IIS restriction enzyme that can specifically bind to R′/R and cleave outside of the recognition sequence to the 5′ side of the second single-stranded overhang of the probe, wherein the first single stranded overhang comprises the sequence 5′-S′₅, S′₄, S′₃, S′₂, S′₁ that is complementary to the sequence in the first five positions of the predetermined oligonucleotide code (5′-S₁, S₂, S₃, S₄, S₅-3′) followed by a position that is represented by all four nucleotides in the probe library (n); wherein the second single-stranded overhang having the sequence 5′-x′, n, n, n, n, n-3′ comprises a nucleotide (x′) that is complementary to the nucleotide to be converted (x) followed by five positions that are represented by all four nucleotides in the probe library, and wherein contacting is performed under conditions that permit one of a plurality of probes in the library to bind and form a perfectly matched duplex with the target ssDNA molecule,

(b) ligating both ends of the shorter strand of the bound probe in step (a) to the target ssDNA with a ligase, thereby forming a circular probe-target ssDNA complex,

(c) contacting the ligated molecule of step (b) with a type IIS restriction enzyme that specifically recognizes the sequence (R′/R) present in the double stranded DNA portion of the probe in step (a), wherein the enzyme cleaves at least one nucleotide on the 3′ end of the target molecule of the target ssDNA to be converted, thereby removing the nucleotide/s from the 3′ end of the target ssDNA molecule; and

(d) separating the double stranded portion of the probe-target ssDNA complex, which was cleaved in step (c), and washing away the oligonucleotides from the unligated strand of the probe;

wherein steps (a)-(d) yield a converted target ssDNA molecule comprising on its 5′ end 5′-x, Xₓ, R-3′, wherein Xₓ is the pre-determined oligonucleotide code corresponding to the converted nucleotide x of the target ssDNA.

Another aspect of the invention disclosed herein relates to a method for converting a target single stranded DNA (ssDNA) molecule starting at its 3′ end such that the nucleotides adenine (A), guanine (G), cytosine (C), or thymine (T) of the target ssDNA molecule are converted to a predetermined oligonucleotide code, and that the order of the nucleotides of the target ssDNA is preserved during conversion. The method comprises the following steps as outlined below:

(a) contacting a target ssDNA molecule having a pre-specified nucleotide sequence on its 5′ end, (e.g., 5′-S₁, S₂, S₃, S₄, S₅-3′) with an oligonucleotide probe library comprising a plurality of probes; wherein each probe comprises a double stranded DNA portion and a first and a second single stranded overhang; wherein the double stranded DNA portion comprises a 5′-3′ nucleotide sequence X′ₓ flanked by the first and second single stranded overhangs, and a nucleotide sequence Xₓ that is complementary to the X′ₓ nucleotide sequence, wherein Xₓ comprises a predetermined oligonucleotide code that uniquely corresponds to a set order of nucleotides A, T, G or C, and represents the nucleotide to be converted; and wherein the double stranded portion of the probe contains a type IIS restriction enzyme recognition site (R), whose cleavage site is complete upon ligation of the probe to the 3′ end of the target ssDNA, of which at least one nucleotide is to be converted; wherein the first single stranded overhang is on the 5′ side of X′ₓ, and the second single stranded overhang is on the 3′ side of X′ₓ; wherein Xₓ comprises on its 5′ end, the pre-specified nucleotide sequence present on the 5′ end of the target ssDNA molecule, wherein the second single stranded overhang comprises a nucleotide, at a position immediately adjacent to the 3′ end of X′ₓ, that is complementary to the nucleotide in the target ssDNA to be converted and further comprises at least 3 random nucleotides; and wherein the first single stranded overhang comprises at least one random nucleotide at a position immediately adjacent to the nucleotide at the 5′ end of X′ₓ, and further comprises a nucleotide sequence complementary to the pre-specified sequence present in the target ssDNA; and wherein contacting is performed under conditions that permit one of the plurality of probes to bind and form a duplex with the target ssDNA molecule;

(b) ligating both ends of the bound double stranded oligonucleotide of step (a) to the target ssDNA sequence, thereby forming a circular molecule;

(c) contacting the ligated molecule of step (b) with a type IIS restriction enzyme corresponding to the type IIS restriction enzyme recognition site present in the double stranded DNA portion of the probe in step (a), wherein the type IIS restriction enzyme cleaves after at least one nucleotide on the 3′ end of the target ssDNA to be converted, thereby removing the nucleotide to be converted from the 3′ end of the target ssDNA molecule.

(d) separating the double stranded portion of the ligated and cut probe of step (c) from the target ssDNA and washing away the unligated strand of the probe;

wherein steps (a)-(d) yield a converted target ssDNA molecule comprising, on its 5′ end, the Xₓ predetermined oligonucleotide code (e.g., x, Xₓ, R-3′) corresponding to the converted nucleotide/s of the target ssDNA (e.g., x) and wherein e.g., the Xₓ predetermined oligonucleotide code precedes the converted nucleotide/s present on the 5′ end of the converted target ssDNA molecule.

One or more nucleotides can be converted at a time (e.g. one nucleotide x, which can be A, T, G, or C, can be converted, or multiple nucleotides representing any combination of A, T, C, or G can be converted (e.g. ATG, or GA etc.).

In another embodiment described herein, each of the plurality of predetermined oligonucleotide codes on the double stranded portion of the probe corresponds uniquely to the converted nucleotide (A, T, G, or C).

In another embodiment described herein, the oligonucleotide library comprises T-shaped probes.

Another aspect disclosed herein is a method for converting a target single stranded (ssDNA) target molecule starting at its 5′ end such that the nucleotides adenine (A), guanine (G), cytosine (C), or thymine (T) of the ssDNA molecule are converted to a predetermined oligonucleotide code, and that the order of the nucleotides of the target ssDNA is preserved during conversion, the method comprising the steps of:

(a) contacting a target ssDNA molecule having a pre-specified nucleotide sequence on its 3′ end with an oligonucleotide probe library comprising a plurality of probes; wherein each probe comprises a double stranded DNA portion and a first and a second single stranded overhang, wherein the double stranded DNA portion comprises a 5′-3′ nucleotide sequence Xₓ′ flanked by the first and second single stranded overhang, and a complementary 3′-5′ nucleotide sequence Xₓ that is complementary to the Xₓ′ nucleotide sequence, wherein Xₓ comprises a predetermined oligonucleotide code that uniquely corresponds to a set order of nucleotides A, T, G or C, and represents the nucleotide to be converted; and wherein the double stranded portion of the probe also contains a type IIS restriction enzyme recognition site (R), whose cleavage site is complete upon ligation of the probe to the 5′ end of the target ssDNA, of which at least one nucleotide is to be converted; wherein Xₓ comprises on its 3′ end the pre-specified nucleotide sequence present on the 3′ end of the target ssDNA molecule; wherein the first single stranded overhang is on the 3′ side of X′ₓ and the second single stranded overhang is on the 5′ end of X′ₓ; wherein the second single stranded overhang comprises a nucleotide, at a position immediately adjacent to the nucleotide at the 5′ end of Xₓ′, that is complementary to the nucleotide in the target ssDNA to be converted and further comprises at least 3 random nucleotides; and wherein the first single stranded overhang comprises at least one random nucleotide at a position immediately adjacent to the nucleotide at the 3′ end of Xₓ′, and further comprises a nucleotide sequence complementary to the pre-specified sequence present in the target ssDNA; and wherein the contacting is performed under conditions that permit one of the plurality of probes to bind to the target ssDNA molecule, thereby forming a circular molecule;

(b) ligating both ends of the bound double stranded oligonucleotide of step (a) to the target ssDNA sequence, thereby forming a circular molecule;

(c) contacting the ligated molecule of step (b) with a type IIS restriction enzyme corresponding to the type IIS restriction enzyme recognition site present in the double stranded DNA portion of step (a), wherein the type IIS restriction enzyme cleaves after at least one nucleotide on the 5′ end of the target ssDNA to be converted thereby removing the nucleotide to be converted from the 5′ end of the target ssDNA molecule; and

(d) separating the double stranded portion of the ligated and cut probe of step (c) from the target ssDNA and washing away the unligated strand of the probe;

wherein steps (a)-(d) yield a converted target ssDNA molecule comprising, on its 3′ end, the predetermined oligonucleotide code corresponding to the converted nucleotide/s of the target ssDNA and wherein the predetermined oligonucleotide code precedes the converted nucleotide/s present on the 3′ end of the converted target ssDNA molecule.

In one embodiment of this aspect and all other aspects disclosed herein, steps (a)-(d) are repeated more than once.

In another embodiment of this aspect and all other aspects disclosed herein, the target ssDNA molecule is immobilized on a solid support or by any other means to ensure that the target ssDNA is not washed away in step (d) as described above.

In another embodiment of this aspect and all other aspects disclosed herein, the pre-specified sequence on the target ssDNA molecule further comprises a recognition site for a type II restriction enzyme (M).

In another embodiment of this aspect and all other aspects disclosed herein, the pre-specified sequence on the target ssDNA (M) ranges from approximately 3 nucleotides to approximately 12 nucleotides. In one embodiment, the length of the overhang is determined by what is required to form a specific duplex between the first overhang of the probe and one end of the target ssDNA.

In another embodiment of this aspect and all other aspects disclosed herein, the type IIS restriction enzyme site is selected from, but not limited to, the group consisting of: AlwI, BccI, BsmA1, EarI, MlyI, PleI, BmrI, BsaI, BsmB1, FauI, HpyAV, MnlI, SapI, BbsI, BciVI, HphI, MboII, BfuaI, BspMI, SfaNI, HgaI, BbvI, EciI, FokI, BceAI, BsmFI, BtgZI, BpmI, BpuEI, BsgI, AclWI, Alw26I, Bst6I, BstMAI, Eam1104I, Ksp632I, PpsI, SchI, BfiI, Bso31I, BspTNI, Eco31I, Esp3I, FauI, SmuI, BfuI, BpiI, BpuAI, BstV2I, AsuHPI, Acc36I, LweI, AarI, BseMII, TspDTI, TspGWI, BseXI, BstV1I, Eco57I, Eco57MI, GsuI, PsrI, or MmeI site.

In another embodiment of this aspect and all other aspects disclosed herein, Xₓ comprises a first nucleic acid sequence, X_{xI}, and a second nucleic acid sequence, X_{xII}, wherein X_{xI} and X_{xII} form a binary pre-specified oligonucleotide code which uniquely corresponds to either nucleotide A, T, G, or C.

In another embodiment of this aspect and all other aspects described herein, the recognition sequence for the restriction enzyme (R) resides at the 5′-end, the 3′ end, or at a desired position within the predetermined oligonucleotide code (Xₓ).

In another embodiment of this aspect and all other aspects disclosed herein, X_{xI} and X_{xII} range from approximately 4 nucleotides to approximately 30 nucleotides each in length.

In another embodiment of this aspect and all other aspects disclosed herein, X_{xI} and X_{xII} are each 12 nucleotides in length.

In one embodiment, the length of each overhang is determined by the length necessary to form a specific duplex between an overhang of the probe and one end of the target ssDNA, i.e. the overhang can be of any length.

In another embodiment of this aspect and all other aspects disclosed herein, the first overhang ranges from approximately 3 nucleotides to approximately 12 nucleotides in length, or any range in between, e.g. 4 nucleotides to 12 nucleotides, 4 to 11 nucleotides, or 5 to 12 nucleotides, or 5 to 11 nucleotides, or 5 to 10 nucleotides in length etc.

In another embodiment of this aspect and all other aspects disclosed herein, the second overhang ranges from approximately 3 nucleotides to approximately 12 nucleotides in length. or any range in between, e.g. 4 nucleotides to 12 nucleotides, 4 to 11 nucleotides, or 5 to 12 nucleotides, or 5 to 11 nucleotides, or 5 to 10 nucleotides in length etc.

In another embodiment of this aspect and all other aspects disclosed herein, the target ssDNA ranges from approximately 5 nucleotides to approximately 3,000,000 nucleotides in length.

In another embodiment of this aspect and all other aspects disclosed herein, a plurality of target ssDNA molecules are converted at the same time.

In another embodiment of this aspect and all other aspects disclosed herein, the conversion is performed on a sample comprising a heterogeneous mixture of target ssDNA nucleic acids.

In another embodiment of this aspect and all other aspects disclosed herein, a polymerase enzyme is not used at any step (a)-(d) in the method.

In another embodiment of this aspect and all other aspects disclosed herein, the probe library has a complexity ranging from 16 to 1,048,576 distinct oligonucleotides.

In another embodiment of this aspect and all other aspects disclosed herein, the target ssDNA molecule is derived from a mammal.

In another embodiment of this aspect and all other aspects disclosed herein, the mammal is a human.

In another embodiment of this aspect and all other aspects disclosed herein, the converted ssDNA molecule is sequenced at the single molecule level.

In another embodiment of this aspect and all other aspects disclosed herein, sequencing comprises one or more labeled molecular beacons.

In another embodiment of this aspect and all other aspects disclosed herein, the labeled molecular beacon is a fluorescent molecular beacon.

In another embodiment of this aspect and all other aspects disclosed herein, the fluorescent molecular beacon binds to an Xₓ sequence (e.g., Xₓ, X_{xI}, or X_{xII}) of the converted ssDNA molecule.

In another embodiment of this aspect and all other aspects disclosed herein, the Xₓ (e.g., Xₓ, X_{xI}, X_{xII}) sequence of the converted ssDNA molecule having a bound fluorescent molecular beacon is directed through a nanopore of diameter <2 nm, wherein the fluorescent molecular beacon is removed as the converted ssDNA molecule passes through the nanopore, wherein removal of the fluorescent molecular beacon produces a flash of light, wherein the order of light flashes yields the sequence of the target ssDNA sequence.

Another aspect described herein is an oligonucleotide probe library comprising T-shaped probes useful for the methods of DNA conversion described herein.

Another aspect described herein is a method for converting a target single stranded DNA (ssDNA) molecule starting at its 3′ end such that the nucleotides adenine (A), guanine (G), cytosine (C), or thymine (T) of the target ssDNA molecule are converted to a predetermined oligonucleotide code, and that the order of the nucleotides of the target ssDNA is preserved during conversion. The method comprises the steps of:

(a) contacting a target ssDNA molecule having a pre-specified nucleotide sequence on its 5′ end with a first probe library and a second probe library, wherein contacting is performed under conditions that permit only one probe in the first library to hybridize to the 5′ end of the target ssDNA, and only one probe of the second probe library to hybridize to the 3′ end of the target ssDNA molecule;

(b) ligating the hybridized probes of step to the target ssDNA sequence;

(c) exposing the ligated molecule of step (b) to a low melting temperature, thereby separating a blocking oligonucleotide from the ligated probe of the second probe library;

(d) hybridizing the 3′ end of the ligated probe from the first probe library to the 5′ end of a ligated probe of the second probe library, thereby forming a circular molecule.

(e) contacting the ligated molecule of step (d) with a type IIS restriction enzyme, wherein the type IIS restriction enzyme cleaves after at least one nucleotide on the 3′ end of the target ssDNA to be converted thereby removing the nucleotide to be converted from the 3′ end of the target ssDNA molecule; and

(f) separating the double stranded portion of each of the ligated and cut probes of step (e) from the target ssDNA and washing away the unligated strands of the probes; wherein steps (a)-(f) yield a converted target ssDNA molecule comprising, on its 5′ end, a predetermined oligonucleotide code of the probe from the second probe library corresponding to the converted nucleotide/s of the target ssDNA, and an invariant sequence of the probe from the first probe library, and wherein the predetermined oligonucleotide code precedes the converted nucleotide/s present on the 5′ end of the converted target ssDNA molecule.

Another aspect described herein relates to a method for converting a target single stranded DNA (ssDNA) molecule starting at its 5′ end such that the nucleotides adenine (A), guanine (G), cytosine (C), or thymine (T) of the target ssDNA molecule are converted to a predetermined oligonucleotide code, and that the order of the nucleotides of the target ssDNA is preserved during conversion. The method comprises the steps of:

(a) contacting a target ssDNA molecule having a pre-specified nucleotide sequence on its 5′ end with a first probe library and a second probe library, wherein contacting is performed under conditions that permit only one probe in the first library to hybridize to the 3′ end of the target ssDNA, and only one probe in the second probe library to hybridize to the 5′ end of the target ssDNA molecule;

(b) ligating the hybridized probes of step (a) to said target ssDNA sequence;

(c) exposing the ligated molecule of step (b) to a low melting temperature, thereby separating a blocking oligonucleotide from a ligated probe of the second probe library;

(d) hybridizing the 3′ end of a ligated probe from the first probe library to the 5′ end of a ligated probe of the second probe library, thereby forming a circular molecule.

(e) contacting the ligated molecule of step (d) with a type IIS restriction enzyme, wherein the type IIS restriction enzyme cleaves after at least one nucleotide on the 5′ end of the target ssDNA to be converted thereby removing the nucleotide/s to be converted from the 5′ end of the target ssDNA molecule; and

(f) separating and washing away the double stranded portion of each of the ligated and cut probes of step (e) from the target ssDNA;

wherein steps (a)-(f) yield a converted target ssDNA molecule comprising, on its 3′ end, a predetermined oligonucleotide code of said probe from the second probe library corresponding to the converted nucleotide of the target ssDNA, and an invariant sequence of the probe from the first probe library, and wherein the predetermined oligonucleotide code precedes the converted nucleotide/s present on the 3′ end of the converted target ssDNA molecule.

In one embodiment of this aspect and all other aspects described herein, for converting a target single stranded DNA molecule starting at its 3′ end, the first probe library comprises a plurality of oligonucleotide probes consisting of four distinct oligonucleotide probes, each comprising a double stranded portion and a first and a second single stranded overhang, wherein the double stranded portion comprises a pre-specified nucleotide spacer sequence (P′) whose 5′ end is unphosphorylated, and a sequence complimentary to the spacer sequence (P), wherein the first single stranded overhang comprises an A, T, G, or C at a position immediately adjacent to the 5′ end of P′, and to the 3′ end of this position a nucleotide sequence complementary to the pre-specified sequence present on the target ssDNA molecule; and wherein the second single stranded overhang comprises a second pre-specified nucleotide sequence identical to a blocking oligonucleotide of the second probe library and is positioned immediately adjacent to the 5′ end of P.

In another embodiment of this aspect and all other aspects described herein, for converting a target single stranded DNA molecule starting at its 3′ end, the second probe library comprises a plurality of oligonucleotide probes, each probe comprising a double stranded portion and a first and second single stranded overhang, wherein the double stranded portion comprises a 5′-3′ nucleotide sequence X′ₓ flanked by the first and second single stranded overhangs and a complementary nucleotide sequence Xₓ, wherein Xₓ comprises a pre-determined oligonucleotide code that uniquely corresponds to a set order of nucleotides A, T, G, or C, and the double stranded nucleotide sequence also comprises a type IIS restriction enzyme recognition site whose corresponding cleavage site is complete upon ligation of the probe to at least one nucleotide on the end of the target ssDNA molecule to be converted, wherein Xₓ comprises on its 5′ end the pre-specified sequence present on the target ssDNA molecule; wherein said first single stranded overhang comprises a nucleotide sequence complementary to the pre-specified sequence present on the target ssDNA molecule; and wherein the second single stranded overhang comprises a nucleotide at a position immediately adjacent to the nucleotide at the 3′ end of X′ₓ that is complementary to the nucleotide in the target ssDNA to be converted and further comprises at least 3 random nucleotides, and wherein the second probe library further comprises a blocking oligonucleotide comprising a 3′-5′ sequence complementary to the first single stranded overhang, wherein the 5′ end of the blocking oligonucleotide and the 5′ end of the first single stranded overhang are unphosphorylated.

In one embodiment of this aspect and all other aspects described herein, for converting a target single stranded DNA molecule starting at its 5′ end, the first probe library comprises a plurality of oligonucleotide probes consisting of four distinct oligonucleotide probes, each comprising a double stranded portion and a first and a second single stranded overhang, wherein the double stranded portion comprises a pre-specified nucleotide spacer sequence (P′), and a sequence complimentary to the spacer sequence (P), wherein the first single stranded overhang comprises an A, T, G, or C at a position immediately adjacent to the 3′ end of P′ and a nucleotide sequence complementary to the pre-specified sequence on the target ssDNA molecule; and wherein the second single stranded overhang comprises a second pre-specified nucleotide sequence identical to a blocking oligonucleotide of the second probe library and is positioned immediately adjacent to the 3′ end of P.

In another embodiment of this aspect and all other aspects described herein, for converting a target single stranded DNA molecule starting at its 5′ end, the second probe library comprises a plurality of oligonucleotide probes, each probe comprising a double stranded portion and a first and second single stranded overhang, wherein the double stranded portion comprises a 5′-3′ nucleotide sequence X′ₓ flanked by the first and second single stranded overhangs and a complementary nucleotide sequence Xₓ, wherein Xₓ comprises a pre-determined oligonucleotide code that uniquely corresponds to a set order of nucleotides A, T , G, or C, and the double stranded nucleotide sequence also comprises a type IIS restriction enzyme recognition site whose corresponding cleavage site is complete upon ligation of the probe to at least one nucleotide on the end of the target ssDNA molecule to be converted, wherein Xₓ comprises on its 3′ end the pre-specified sequence present on the target ssDNA molecule; wherein said first single stranded overhang comprises a nucleotide sequence complementary to the pre-specified sequence present on the target ssDNA molecule; and wherein the second single stranded overhang comprises a nucleotide at a position immediately adjacent to the nucleotide at the 3′ end of X′ₓ that is complementary to the nucleotide in the target ssDNA to be converted and further comprises at least 3 random nucleotides, and wherein the second probe library further comprises a blocking oligonucleotide comprising a 3′-5′ sequence complementary to the first single stranded overhang, wherein the 5′ end of the blocking oligonucleotide and the 5′ end of the first single stranded overhang are unphosphorylated.

### BRIEF DESCRIPTION OF THE FIGURES

FIG. 1. A schematic representation depicting a model for preparing a target ssDNA for conversion.

FIG. 2. A schematic representation of an exemplary oligonucleotide probe present in a probe library for Level I conversion.

FIGS. 3A-3D. A schematic depiction of the steps for Level I conversion; (FIG. 3A) an exemplary probe hybridizing specifically to a target ssDNA molecule whose 3′ end is to be converted, (FIG. 3B) ligation at two locations to form a circular molecule and washing away unbound probes, (FIG. 3C) an exemplary type IIS restriction enzyme binds to R/R′, and cleaves precisely at the 5′ end of x₁, the nucleotide being converted, (FIG. 3D) separation of the duplexes and washing away unbound strands. The resulting target ssDNA molecule in this schematic has been extended on its 5′ end by 5′-x₁, Xₓ, R-3′, and shortened in its 3′ end by one nucleotide x₁.

FIGS. 4A-4B. A schematic representation of an exemplary oligonucleotide probe present in Library I (FIG. 4A) and an exemplary oligonucleotide probe present in Library II (FIG. 4B) for Level II conversion.

FIGS. 5A-5G. A schematic depiction of the steps for Level II conversion; (FIG. 5A) two probes hybridizing specifically to one target ssDNA molecule, with one probe on each end, (FIG. 5B) ligation at two locations and washing away unbound probes, (FIG. 5C) low temperature melting, which only displaces the blocking oligonucleotide but does not separate other double stranded portions of the probe-target ssDNA complex, (FIG. 5D) ligation at one location to produce a circular molecule, (FIG. 5E) an exemplary type IIS restriction enzyme binds specifically to R′/R and cleaves precisely at the 5′ end of x₁, the nucleotide being converted, (FIG. 5F) separation of the duplexes and washing away unbound strands. The resulting target ssDNA molecule has been extended in its 5′ end by 5′-x₁, Xₓ, R, q′₁, q′₂, q′₃, q′₄, q′₅, P-3′ and shortened in its 3′ end by one nucleotide x₁, (FIG. 5G) the first step in the second cycle of the conversion.

FIG. 6. A schematic representation depicting a model for preparing a target ssDNA for conversion starting at its 5′ end.

FIGS. 7A-7C. FIG. 7A, Gel showing binding of universal probes to templates. Gel shows top and bottom primers (TP and BP) as well as the ssDNA template in lanes 2-4 respectively. Lane 7 shows ligated target formation after hybridisation. In the absence of ligase enzyme no target is formed (lanes 5 and 6). FIG. 7B, 8%-Urea Denaturing gel indicating template circularization. The 8%-Urea Denaturing gel shows that universal probe ligated ssDNA template (133 bases) is effectively circularized in the presence of PNK kinase and ligase (lane 10). Band positions of linear and circularized template DNA as compared with the control experiments show the right DNA length. Positive control experiments (lanes 1-6) with TP20-20 as primer and corresponding templates PP100 and PP150 also circularise under the same conditions. FIG. 7C, Gel showing linearization of circular DNA after digestion with BseG1 to form linear ssDNA template with 2-bit sequence ligated to its 3′ end. Lanes 1 and 2 run the reference DNA and lanes 4 and 5 run the sample before and after digestion respectively.

FIGS. 8A-8B. FIG. 8A, schematic of RCA based verification of DNA conversion. Converted DNA, used as padlock probe for primers differing by 1 base. (FIG. 8B) 0.8% Agarose gel after 30 min of RCA. Lane 1 has the 1 kb DNA ladder. Lanes 2 and 3 are negative and positive reactions with control templates and Phi29 DNA polymerase with and without ligase enzyme, respectively. Lanes 4-7 are RCA reactions with 4 primers with the centre base as A, T, C and G respectively. Products are seen only with the primer with the right base at the site of ligation (lane 7).

### DETAILED DESCRIPTION

Described herein is a method for sequentially converting each nucleotide of a target single stranded nucleic acid, such as DNA or RNA, to a pre-determined code, which represents the order of nucleotides adenine (A), thymine (T)/uracil (U) guanine (G) and cytosine (C), of a target nucleic acid sequence. Following conversion, each nucleotide of the target sequence (e.g., a target ssDNA) is separated by a known sequence (i.e., a pre-determined oligonucleotide code sequence) that can further bind a molecular beacon. One aspect of the methods described herein relates to DNA conversion that requires the formation of a circular molecule and leads to the movement of the converted base from one end of the ssDNA to the other end. In addition, another aspect described herein relates to the use of an oligonucleotide probe library, comprising T-shaped probes, for the purpose of converting a ssDNA molecule.

In one embodiment such conversion permits the converted single stranded molecule to be sequenced through the use of nanopore sequencing. In this embodiment, one bound molecular beacon is removed at a time in sequential order as the converted strand moves through a nanopore. Removing a molecular beacon produces a flash of light, which represents the order of the predetermined code, and also translates to the order of the nucleotides in the target ssDNA. This system has several advantages: (a) the sequence of the target ssDNA can be unknown, (b) no polymerase or amplification step is necessary, (c) a gel separation system is not required for the practice of the methods described herein, and (d) the system can be automated for rapid sequencing. The method of conversion of a target ssDNA described herein permits rapid sequencing at the single molecule level. In one embodiment, a target ssDNA can be sequenced in less than one week; preferably the target ssDNA molecule is sequenced in less than 72 hours, less than 48 hours, less than 24 hours, less than 12 h, less than 6 hours, less than 2 hours or even less than one hour (e.g., 45 minutes, 30 minutes, 15 minutes, etc.).

For convenience, certain terms employed herein, in the specification, examples and appended claims are collected here. Unless stated otherwise, or implicit from context, the following terms and phrases include the meanings provided below. Unless explicitly stated otherwise, or apparent from context, the terms and phrases below do not exclude the meaning that the term or phrase has acquired in the art to which it pertains. The definitions are provided to aid in describing particular embodiments, and are not intended to limit the claimed invention, because the scope of the invention is limited only by the claims. Unless otherwise defined, all technical and scientific terms used herein have the same meaning as commonly understood by one of ordinary skill in the art to which this invention belongs.

As used herein, the term “conversion” is used to describe the process of substituting an oligonucleotide code to represent a given nucleotide, for example such that the code can be used for further sequencing and thus it is not necessary for the sequencing method to read at the single nucleotide level. The term “conversion” is also intended to encompass conversion of more than one nucleotide at a time (e.g., at least 2, at least 3, at least 4, at least 5, at least 6, or more nucleotides to be converted at one time). The term “converted ssDNA” or “converted target ssDNA” is used to describe a DNA molecule that has undergone at least one round of conversion. The oligonucleotide code used as a representative of each given nucleotide in a converted ssDNA is also referred to herein as a “predetermined oligonucleotide code”, which can comprise a binary code as described in the Detailed Description herein. “Level 1 conversion” is used herein to refer to a method of conversion using only one probe library, while “Level 2” conversion is used herein to refer to a method of conversion using two distinct probe libraries. Level 2 conversion has the advantage of increased efficiency of conversion, since it prevents binding of a probe to each end of a target ssDNA molecule and the impaired conversion that can occur during Level 1 conversion.

The terms “probe” and “oligonucleotide probe” are used herein to refer to an oligonucleotide produced synthetically, which is capable of annealing with or specifically hybridizing to a nucleic acid that comprises a sequence complementary to the probe. The exact length of the probe will depend upon many factors, including temperature, type IIS restriction enzyme used, number of copies of each probe in a probe library and the method used. An oligonucleotide probe, for use in the methods described herein for Level 1 conversion, comprises a double stranded portion with two flanking single stranded overhangs each on both ends of one strand. Such probes are also referred to herein as ‘conversion probes’.

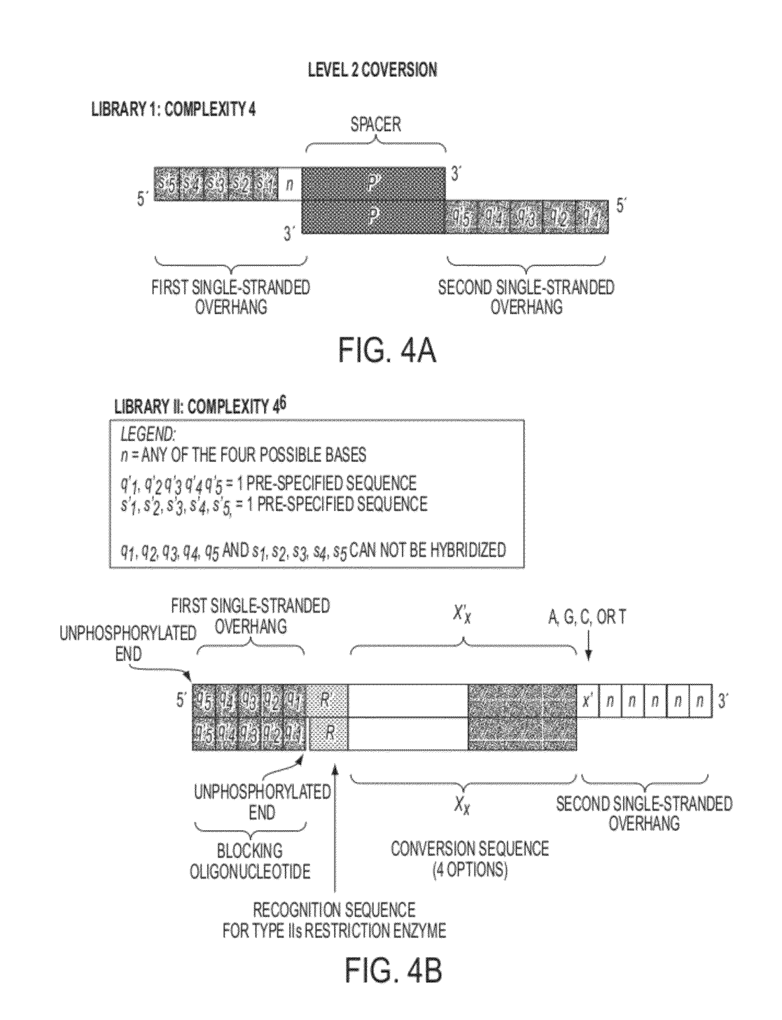

As used herein, the term “probe library” refers to a plurality of distinct oligonucleotide probes in an admixture. The probe library has a certain “complexity”, which is used herein to describe the number of distinct oligonucleotides in a probe library. For example, a library with a complexity of 4⁷, comprises 4⁷ (i.e., 16,384) distinct oligonucleotide probes. The term ‘complexity’ does not describe the presence of more than one copy of each distinct oligonucleotide probes, but rather describes the number of unique probes in a library. The complexity of a library is determined by the number of random (e.g., degenerate) nucleotide combinations generated using a desired template probe sequence, wherein n or x₀ is used to represent each of the nucleotides A, T/U, C, and G (note that the nucleotide to be converted, x, can also be an A, T/U, C, or G). For example, if there are 2 random nucleotides (designated as n or x₀) in a probe sequence and there are 4 possible DNA nucleotides (e.g., A, T, C, and G) for each n, the library has a complexity of 4², or 16 distinct oligonucleotides. Therefore, the library comprises all the possible combinations of A, T, C, and G (and optionally indiscriminate binding nucleotides, such as inosine (I)) for a set length of a probe in order for at least one probe to specifically hybridize with an unknown region on a target ssDNA molecule (i.e., knowledge of the target ssDNA sequence is not necessary for the methods described herein). There are three probe libraries that are useful in the methods described herein: (a) a probe library for Level 1 conversion, (b) two libraries for Level 2 conversion (referred to herein as Library I and Library II; see Detailed description). Exemplary probes in each library are shown in FIGS. 2 and 4. It should be noted that conversion can be performed starting from either the 3′ end or 5′ end of the target molecule. An exemplary probe for each type of conversion is described in the Detailed Description section for Level 1 conversion. It should be understood that a skilled artisan can adapt the probe libraries for both Level 1 (FIG. 2) and Level 2 (FIG. 4) conversion to convert the 5′ end of a target molecule.

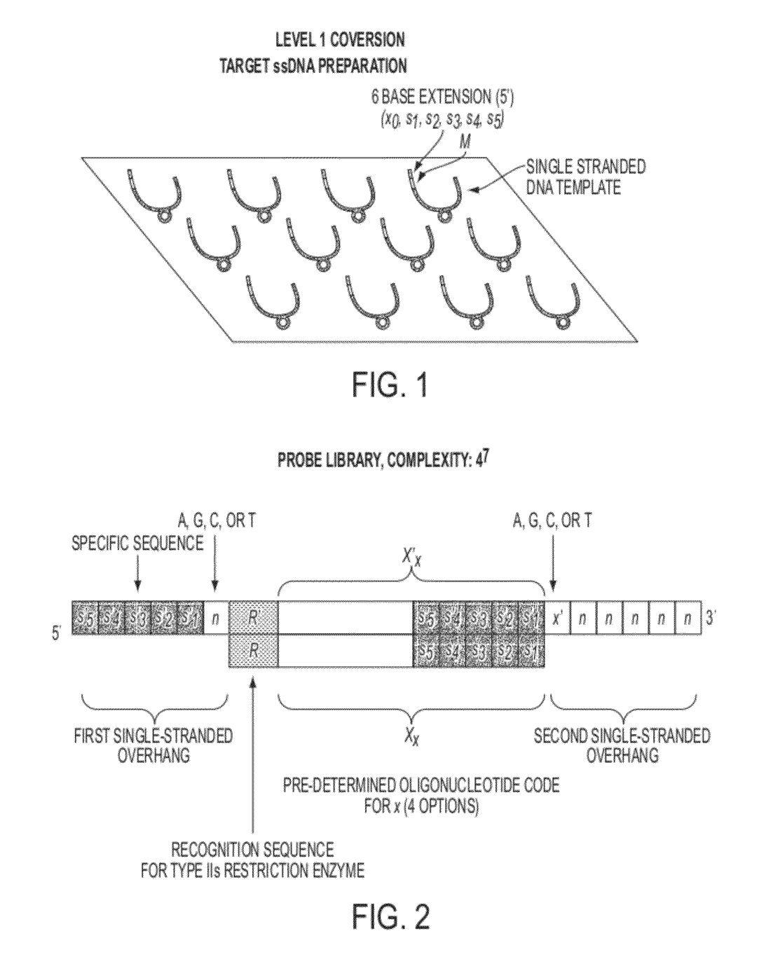

The term “pre-specified nucleotide sequence” is used to describe a known nucleotide sequence that is ligated to one end of the target single stranded nucleic acid to be converted, e.g., ssDNA, which is attached to one end (e.g., either the 5′ or the 3′ end) of a target ssDNA molecule (e.g., see FIG. 1, wherein the pre-specified sequence designated as 5′-x₀, S₁, S₂, S₃, S₄, S₅-3′ is attached to the 5′ end of the target ssDNA). The pre-specified nucleotide sequence is complementary to a nucleotide sequence incorporated into each probe and is necessary for the first round of sequence preserved DNA conversion. The pre-specified nucleotide sequence can also comprise a Type II restriction enzyme recognition site (e.g., see FIG. 1, M).

The term “target ssDNA molecule” is used herein to describe a single stranded DNA to be converted. The target ssDNA molecule can be derived from a double stranded DNA molecule (e.g., a genomic DNA sample) that has been denatured from its native duplex conformation to a single stranded conformation. The term “target ssDNA molecule” also encompasses fragments of a ssDNA molecule or short ssDNAs (e.g., 500 bp, 1 Kb, 2 Kb, 5 Kb, 16 Kb, etc.). It is also contemplated herein that a target single stranded nucleic acid, e.g., RNA, can be converted with the methods disclosed herein. The term “target single stranded nucleic acid” also encompasses single stranded RNA. For illustration purposes, target ssDNA molecules are used throughout the description as an example of the methods described herein. One of skill in the art can readily adapt these methods for the conversion of RNA molecules, if desired.

The term “specifically hybridize” refers to the association between two single-stranded nucleic acid molecules of sufficiently complementary sequence to permit such hybridization under pre-determined conditions generally used in the art (sometimes termed “substantially complementary”). In one embodiment, one uses at least moderate stringency conditions. In another embodiment one uses high stringency conditions. In particular, the term refers to hybridization of an oligonucleotide with a substantially complementary sequence contained within a single-stranded DNA molecule of the invention, to the substantial exclusion of hybridization of the oligonucleotide with single-stranded DNA of non-complementary sequence.

“Complementary” refers to the broad concept of sequence complementarity between regions of two nucleic acid strands or between two regions of the same nucleic acid strand. For example, it is known that an adenine residue of a first nucleic acid region is capable of forming specific hydrogen bonds (“base pairing”) with a residue of a second nucleic acid region which is anti-parallel to the first region if the residue is thymine or uracil. Similarly, it is known that a cytosine residue of a first nucleic acid strand is capable of base pairing with a residue of a second nucleic acid strand, which is anti-parallel to the first strand, if the residue is guanine A first region of a nucleic acid is complementary to a second region of the same, or a different nucleic acid, if when the two regions are arranged in an anti-parallel fashion, at least one nucleotide residue of the first region is capable of base pairing with a residue of the second region. In one embodiment, the first region comprises a first portion and the second region comprises a second portion, whereby, when the first and second portions are arranged in an anti-parallel fashion, at least about 50%, and at least about 75%, at least about 90%, or at least about 95%, or at least about 99% of the nucleotide residues of the first portion are capable of base pairing with nucleotide residues in the second portion. In one embodiment, all nucleotide residues (e.g., 100%) of the first portion are capable of base pairing with nucleotide residues in the second portion.

As used herein, the phrase “type IIS restriction enzyme cleavage site is complete upon ligation” is used to describe a sequence of nucleotides present on an oligonucleotide probe that is missing at least one nucleotide in a cleavage site of a type IIS enzyme and thus contact with a type IIS restriction enzyme does not result in cleavage of the duplex DNA. The cleavage site is completed upon binding of an oligonucleotide probe to its complementary target ssDNA, which provides the missing nucleotide(s), and forms a duplex DNA region, and thus permits cleavage to occur upon contact with a type IIS restriction enzyme. A type IIS restriction enzyme is one that recognizes an asymmetric site on a double stranded DNA molecule and cleaves at a site distant from its recognition site.

As used herein, the term “invariant sequence” is used to describe a nucleotide sequence that is inserted during each round of conversion and is not dependent on the nucleotide to be converted, x. The invariant sequence is incorporated into the probes used herein, such that the invariant sequence is inserted after each round of conversion. A distinct molecular beacon can bind to the invariant sequence, which permits the “frame” of the pre-determined oligonucleotide code to be assessed during sequencing. This is especially useful in embodiments wherein a binary code is used for sequencing, thus the invariant sequence serves as a “comma” that permits each frame to be separated from the previous one. The “frame”, for example, refers to the binary code read-out, wherein two molecular beacons are read for each round of conversion, such that if only one of the molecular beacons is read in a round a “frame shift” would occur. When an invariant sequence is incorporated during each round of conversion, the read-out would indicate if a “frame shift” occurs. For example, the binary code may be 00, 11, 01, 01 (note that the commas are indicated by the invariant sequence), however if a frame shift occurred in the 3^{rd} position, the read-out in the presence of an invariant sequence would read 00, 1, 01, 01. In the absence of the invariant sequence the read-out would be 00, 10, 10, 1, which would introduce an error into the order of the sequence. Therefore, the invariant sequence provides a mechanism to reduce potential errors in the read-out of a converted sequence.

For ease of reference the strands of a duplex DNA molecule are denoted according to the position of the terminal phosphate group and the terminal hydroxyl group on the DNA strand. A DNA strand is referred to as a 5′-3′ directional strand and is denoted by a 5′ phosphate group and a 3′ hydroxyl group; this strand is depicted in the figures shown herein as the “upper” or “top” strand denoted by S′, x′ or q. The complement to the 5′-3′ directional strand is denoted from left to right as a 3′-5′ directional strand and is depicted in the figures shown herein as the “lower” or “bottom” strand denoted by S, x, or q′.

As used herein, “stringent conditions” are conditions that permit specific hybridization of a substantially complementary oligonucleotide probe to a target ssDNA molecule to be converted, but does not permit non-complementary oligonucleotide probes to bind to a target ssDNA molecule. Stringency of hybridization and wash buffers can be altered by changing incubation temperatures or buffer compositions (e.g., salt concentrations, detergent, pH, etc). Stringent hybridization conditions can vary (e.g., from salt concentrations of less than about 1M, more usually less than about 500 mM and preferably less than about 200 mM) and hybridization temperatures can range (e.g., from as low as 0° C. to greater than 22° C., greater than about 30° C., and (most often) in excess of about 37° C.) depending upon the lengths and/or the nucleic acid composition of the oligonucleotide probes. Stringency may be increased, for example, by washing at higher temperatures (e.g., 55° C. or more preferably 60° C.) using an appropriately selected wash medium having an increase in sodium concentration (e.g., 1×SSPE, 2×SSPE, 5×SSPE, etc.). If problems remain with cross-hybridization, further increases in temperature can also be selected, for example, by washing at 65° C., 70° C., 75° C., or 80° C. Longer fragments may require higher hybridization temperatures for specific hybridization. The skilled artisan is aware of various parameters which may be altered during hybridization and washing, which will either maintain or change the stringency conditions (see e.g., Sambrook, J., E. F. Fritsch, et al. 1989 “Molecular Cloning: a Laboratory Manual, 2nd Edition, Cold Spring Harbor, N.Y., Cold Spring Harbor Laboratory Press, at 11.45). As several factors affect the stringency of hybridization, the combination of parameters is more important than the absolute measure of a single factor.

As used herein the term “comprising” or “comprises” is used in reference to compositions, methods, and respective component(s) thereof, that are essential to the invention, yet open to the inclusion of unspecified elements, whether essential or not.

As used herein the term “consisting essentially of” refers to those elements required for a given embodiment. The term permits the presence of additional elements that do not materially affect the basic and novel or functional characteristic(s) of that embodiment of the invention.

The term “consisting of” refers to compositions, methods, and respective components thereof as described herein, which are exclusive of any element not recited in that description of the embodiment.

As used in this specification and the appended claims, the singular forms “a,” “an,” and “the” include plural references unless the context clearly dictates otherwise. Thus for example, references to “the method” includes one or more methods, and/or steps of the type described herein and/or which will become apparent to those persons skilled in the art upon reading this disclosure and so forth.

It is understood that the foregoing detailed description and the following examples are illustrative only and are not to be taken as limitations upon the scope of the invention. Various changes and modifications to the disclosed embodiments, which will be apparent to those of skill in the art, may be made without departing from the spirit and scope of the present invention. Further, all patents, patent applications, and publications identified are expressly incorporated herein by reference for the purpose of describing and disclosing, for example, the methodologies described in such publications that might be used in connection with the present invention. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents are based on the information available to the applicants and do not constitute any admission as to the correctness of the dates or contents of these documents.

### Target Nucleic Acid Templates

### Sources

The methods described herein are contemplated for the conversion of any single stranded nucleic acid molecule including, for example RNA and ssDNA. Target single stranded nucleic acids can be derived from a variety of sources including, for example genomic DNA, double stranded DNA, cDNA, mRNA, tRNA, rRNA, siRNA, miRNA, shRNA or reverse transcribed DNA. The single stranded DNA can be prepared from a double stranded DNA that occurs naturally e.g., genomic DNA, or alternatively can be engineered, for example a cDNA construct. It is not necessary that the target nucleic acid molecule contain a region of known sequence, as the methods described herein permit sequencing of a completely unknown sequence. In addition, the target nucleic acid need not be an entire genomic sequence or full-length RNA molecule, but rather a target nucleic acid can be a shorter sequence (i.e., 500 bp, 1 Kb, 2 Kb, 16 Kb). However, conversion of an entire genome is also contemplated herein, as well as fragmented genomic DNA. The methods of conversion described herein can be used, for example to convert an entire genome that has been fragmented into smaller pieces, such that the initial DNA sequence can be reconstructed from the various fragment sequences.

Target nucleic acid molecules can be isolated from any species by methods known to those skilled in the art. Target nucleic acids include but are not limited to those comprised by bacteria, viruses, fungi, plants, animals, etc., including humans.

Nucleic acid samples can be derived from a biological sample. Some non-limiting examples of biological samples include a blood sample, a urine sample, a semen sample, a lymphatic fluid sample, a cerebrospinal fluid sample, a plasma sample, a serum sample, a pus sample, an amniotic fluid sample, a bodily fluid sample, a stool sample, a biopsy sample, a needle aspiration biopsy sample, a swab sample, a mouthwash sample, a cancer sample, a tumor sample, a tissue sample, a cell sample, a cell lysate sample, a crude cell lysate sample, a forensic sample, an environmental sample, an archeological sample, an infection sample, a nosocomial infection sample, a community-acquired infection sample, a biological threat sample, a production sample, a drug preparation sample, a biological molecule production sample, a protein preparation sample, a lipid preparation sample, a carbohydrate preparation sample, or any combination thereof. Other non-limiting examples of biological samples include a bacterial colony, a bacterial cell, a bacteriophage plaque, a bacteriophage, a virus plaque, a virus, a yeast colony, a yeast cell, a baculovirus plaque, a baculovirus, a biological agent, an infectious biological agent, a eukaryotic cell culture, a eukaryotic cell, a culture of transiently transfected eukaryotic cells, or a transiently transfected eukaryotic cell.

In one embodiment the target DNA molecule is derived from an individual in need of rapid sequencing analysis, for example an individual to be pre-screened for genetic polymorphisms prior to being prescribed a drug by a clinician.

In one embodiment the target DNA molecule is derived from an infected individual, for example one HIV positive individual considered for an antiviral therapy, for which a large number of HIV genomes need to be sequenced.

Preparation of Target ssDNA

In one embodiment the nucleic acid to be converted is a DNA molecule. Single stranded DNA molecules can be prepared for conversion in a variety of ways. In cases when a target DNA is obtained in a double stranded form (e.g., from a biological sample), the DNA can be fragmented into smaller pieces and denatured to yield single-stranded fragments. For example, by treating a double stranded DNA (dsDNA) with DNase, sonication, vortexing, or other similar techniques nucleic acid molecules can be fragmented into pieces. Denaturation can be performed, for example by heating a target dsDNA to approximately 95° C. Such techniques are known to those of skill in the art. By adjusting the parameters of these techniques, it is possible to adjust the average size of the target DNA fragments. These methods are relatively non-specific with respect to where they cut/break the DNA molecule so that generally DNA pieces are obtained that are cut/broken throughout the entire sequence.

A pre-specified sequence is necessary for the conversion methods described herein and in one embodiment can be attached to either end of a target ssDNA molecule using a single stranded DNA ligase such as (FIG. 1), for example T4 RNA ligase 1 (NEB, Ipswich, Mass.). Methods for ligation are well known to one of skill in the art.

In an alternate embodiment, the genome is sheared by mechanical means or enzyme cleavage to produce fragmented dsDNA. Some restriction enzymes such as EcoRV (NEB, Ipswich, Mass.) cleave to produce blunt ends. Alternatively, the ends of the dsDNA molecule are converted to blunt ends with enzymes such as E. coli DNA polymerase I large fragment (Klenow fragment) or T4 DNA polymerase. A phosphatase may be applied to prevent self ligation of the dsDNA. A pre-specified oligonucleotide tag, one end of which (the non-ligating end) can be biotinylated, is then ligated to the target dsDNA fragments using a T4 DNA ligase. The DNA is then treated (e.g., by heating) to separate the two strands and produce single stranded DNA fragments with a biotinylated end. Methods for these steps are well known to one of skill in the art.

Solid Supports

In one embodiment of the present invention, a target nucleic acid is immobilized to a solid substrate. The immobilization of a target single stranded nucleic acid permits both removal of unincorporated probes and separate enzyme treatments to be performed with intervening wash steps without substantial loss of target single stranded nucleic acid fragments during the process of conversion. The immobilization has the additional advantage of facilitating spatial separation of individual target ssDNA molecules so that a single probe hybridizes to only one ssDNA molecule.

In its simplest version, the solid support comprises a glass slide to which biotinylated target nucleic acid sequences bind. In one embodiment of the invention, the target single-stranded nucleic acid is anchored to a solid phase support, such as a magnetic particle, polymeric microsphere, filter material, or the like, which permits the sequential application of reagents without complicated and time-consuming purification steps.

A variety of other solid substrates can be used, including, without limitation, the following: cellulose; nitrocellulose; nylon membranes; controlled-pore glass beads; acrylamide gels; polystyrene matrices; activated dextran; avidin/streptavidin-coated polystyrene beads; agarose; polyethylene; functionalized plastic, glass, silicon, aluminum, steel, iron, copper, nickel, and gold; tubes; wells; microtiter plates or wells; slides; discs; columns; beads; membranes; well strips; films; chips; and composites thereof. In one embodiment, a portion of the surface of a solid substrate is coated with a chemically functional group to allow for covalent binding of, for example the target ssDNA, to the surface of the solid substrate. Solid substrates with the functional group already included on the surface are commercially available. In addition, the functional groups may be added to the solid substrates by the practitioner.

A number of methods can be used to couple e.g., a target ssDNA to a solid substrate, including, without limitation: covalent chemical attachment; biotin-avidin/streptavidin; and UV irradiation (see for example, Conner et al., Proc. Natl. Acad. Sci. 80(1):278-282 (1983); Lockley et al., Nucleic Acids Res. 25(6):1313-1314 (1997), which are hereby incorporated by reference in their entirety).

A target nucleic acid/solid substrate linkage can include, without limitation, the following linkage types: disulfide; carbamate; hydrazone; ester; (N)-functionalized thiourea; functionalized maleimide; streptavidin or avidin/biotin; mercuric-sulfide; gold-sulfide; amide; thiolester; azo; ether; and amino.

If a solid substrate is made of a polymer, it can be produced from, without limitation, any of the following monomers: acrylic acid; methacrylic acid; vinylacetic acid; 4-vinylbenzoic acid; itaconic acid; allyl amine; allylethylamine; 4-aminostyrene; 2-aminoethyl methacrylate; acryloyl chloride; methacryloyl chloride; chlorostyrene; dischlorostyrene; 4-hydroxystyrene; hydroxymethyl styrene; vinylbenzyl alcohol; allyl alcohol; 2-hydroxyethyl methacrylate; poly(ethylene glycol) methacrylate; and mixtures thereof, together with one of the following monomers: acrylic acid; acrylamide; methacrylic acid; vinylacetic acid; 4-vinylbenzoic acid, itaconic acid; allyl amine; allylethylamine; 4-aminostyrene; 2-aminoethyl methacrylate; acryloyl chloride; methacryloyl chloride; chlorostyrene; dichlorostyrene; 4-hydroxystyrene; hydroxymethyl styrene; vinylbenzyl alcohol; allyl alcohol; 2-hydroxyethyl methacrylate; poly(ethylene glycol) methacrylate; methyl acrylate; methyl methacrylate; ethyl acrylate; ethyl methacrylate; styrene; 1-vinylimidazole; 2-vinylpyridine; 4-vinylpyridine; divinylbenzene; ethylene glycol dimethacrylate; N,N′-methylenediacrylamide; N,N′-phenylenediacrylamide; 3,5-bis(acryloylamido) benzoic acid; pentaerythritol triacrylate; trimethylolpropane trimethacrylate; pentaerytrithol tetraacrylate; trimethylolpropane ethoxylate (14/3 EO/OH) triacrylate; trimethylolpropane ethoxylate (7/3 EO/OH) triacrylate; trimethylolpropane propoxylate (1 PO/OH) triacrylate; trimethylolpropane propoxylate (2 PO/OH) triacrylate; and mixtures thereof.

A solid substrate should withstand changes in temperature necessary for the methods described herein, as well as enzymatic processes, buffer systems, and repetitive wash steps performed during the method.

When immobilizing the e.g., target ssDNA sequence to a substrate, the target ssDNA molecules should be spaced sufficiently far from each other on a solid support to prevent ligation of a single probe to two target ssDNA fragments. The distance between each molecule is dependent on the approximate length of each fragment and can vary from 1 to 1000 nm.

### Level 1 Probe Library

A method is described herein for sequentially converting each nucleotide in a target ssDNA molecule into a converted ssDNA molecule, wherein each converted nucleotide is separated by a known sequence that represents that nucleotide. In one embodiment, the method of conversion comprises the following steps: (a) preparation of a fragmented target template by ligating a pre-specified sequence to one end of the molecule and immobilizing the target ssDNA template onto a solid support, (b) contacting the immobilized target ssDNA molecule with an oligonucletide probe library comprising a plurality of distinct oligonucleotide probes under conditions permissible for specific hybridization, (c) contacting the hybridized target ssDNA/probe complex with a DNA ligase to form a target ssDNA/probe reaction circle, (d) contacting the target ssDNA/probe circle with a desired Type IIS restriction enzyme, (e) separating and washing away the double stranded portion of the bound probe, and (f) repeating steps (a)-(e) as desired. Each of the steps is separated by an intervening wash step. An exemplary method of conversion is described herein in more detail.

The probes for use in the methods described herein for Level 1 conversion comprise a double stranded portion and two single stranded overhangs. A “probe library” comprises a plurality of distinct oligonucleotides with multiple copies of each distinct oligonucleotide in one mixture. The number of distinct oligonucleotides determines the “complexity” of the library and is determined by the number of random (e.g., degenerate) nucleotides in each probe, such that probes comprising all possible combinations of A, T/U, C and G are accounted for in one library.

For the purposes of illustration only see FIG. 2, which depicts an exemplary oligonucleotide probe of the probe library for Level 1 conversion. The probe described in FIG. 2 is useful for converting a target ssDNA molecule from its 3′ end, however it is also contemplated herein that a target ssDNA molecule is converted from its 5′ end with an analogous probe configuration. Each probe has a double stranded region, flanked by two single stranded overhangs. Both overhangs are comprised by the same strand (5′-3′; i.e., upper strand) and are thus separated by the 5′-3′ directional strand of the double stranded portion of the probe. In this example, the nucleotides labeled 5′-S′₅, S′₄, S′₃, S′₂, S′₁-3′ present on the first single stranded overhang of the probe form a pre-specified sequence, that is complementary to the pre-specified sequence attached to one end of a target ssDNA molecule. The first single stranded overhang also comprises at least one random (e.g., degenerate) nucleotide (note that this overhang will have 4 distinct combinations, one for each nucleotide A, T/U, C or G). The overhang on the 3′ end of the double stranded portion of the probe comprises 6 random nucleotides (e.g., 4096 possible combinations of A, T/U, C, G for a given nucleotide sequence). The nucleotide immediately adjacent to the double stranded portion is complementary to the nucleotide of the target ssDNA to be converted, and is designated as x′ in FIG. 2. The length of each overhang can vary from as little as 3 nucleotides to as many as 12 nucleotides. It is important to note that as the length of the overhangs on the probe increase, so does the complexity of the probe library. For example, a probe with a 3′ overhang of 12 nucleotides requires a library with complexity of 4¹³ (i.e., 11 degenerate nucleotides plus x on the 3′ overhang; plus at least one degenerate nucleotide on the 5′ overhang). The oligonucleotide probe for Level 1 conversion (FIG. 2) comprises a double stranded DNA portion having a recognition sequence of a type IIS restriction enzyme (R′/R) and a pre-determined oligonucleotide code (Xₓ)). In one embodiment, R′/R is within X′ₓ/Xₓ.

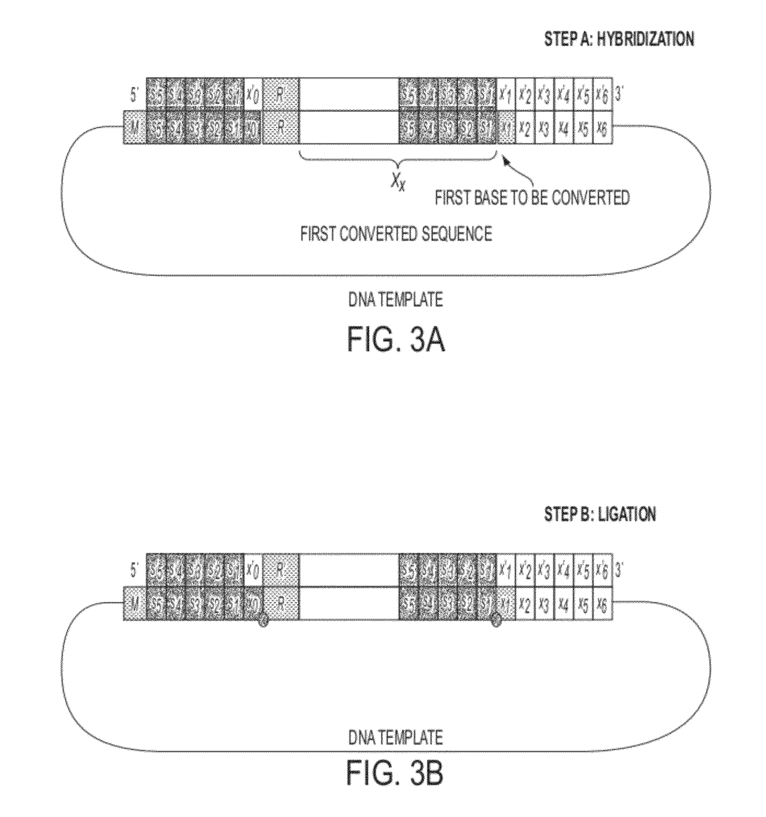

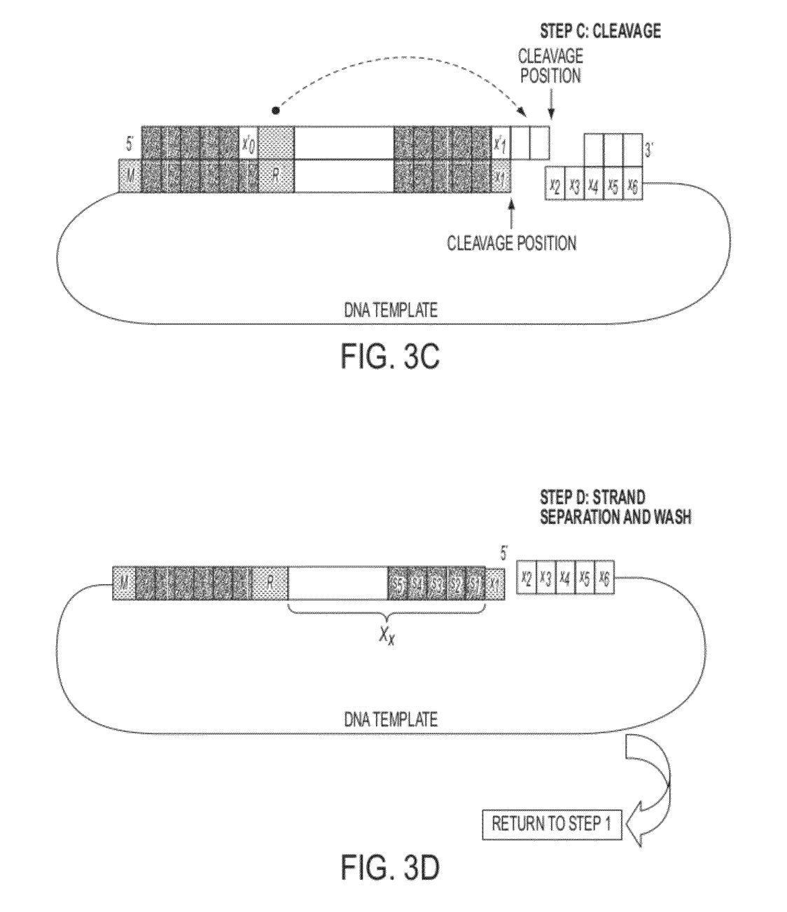

An exemplary probe shown in FIG. 2 is contacted with a type IIS restriction enzyme that binds to (R′/R), and cleaves outside of its recognition sequence to the 5′ side of the second single-stranded overhang (FIG. 3c). In this example, the first single stranded overhang comprises the sequence 5′-S′₅, S′₄, S′₃, S′₂, S′₁-3′ that is complementary to the sequence in positions 2-6 of the pre-determined oligonucleotide code (5′-S₁, S₂, S₃, S₄, S₅-3′) of the target ssDNA, followed by a position that is represented by all four nucleotides in the probe library (n), one of which is complementary to the first position of the predetermined oligonucleotide of the target ssDNA (x₀); the second single stranded overhang (5′-x′,n,n,n,n,n-3′) comprises a sequence that is complementary to the nucleotide to be converted (x) followed by 5 positions that are represented by all four nucleotides in the probe library. FIG. 3a shows one embodiment of a probe hybridizing to a target ssDNA under conditions that permit one of a plurality of probes in the library to form a perfectly matched duplex with a target ssDNA molecule (note that x₁ is the nucleotide to be converted in this example).

The double stranded portion of the probe comprises a pre-determined known sequence, designated as X′ₓ, and the complementary strand Xₓ, as shown in FIG. 2. In one embodiment, the complement of the known sequence binds to a specified molecular beacon. The double stranded portion of the probe further comprises a type IIS restriction enzyme recognition site. The restriction site is encoded in a region such that the restriction enzyme recognizes the site and cleaves at least one nucleotide (designated as x₁ in FIG. 3) from the target ssDNA (e.g., the nucleotide to be converted). Thus, for the example shown in FIG. 3, the 3′ terminal nucleotide of the target ssDNA molecule supplies the necessary nucleotide for completion of the restriction enzyme cleavage site. It is important to consider the cleavage characteristics of the restriction enzyme chosen in respect to the position of the recognition site such that a desired number of nucleotides are converted in each round. Thus, if two nucleotides are desired to be converted, it is necessary that the cleavage site cuts such that two terminal nucleotides are transferred from one terminus of the target ssDNA molecule to the other. Thus, the position of the recognition site in the probe should be an appropriate distance for the desired enzyme to achieve the correct cleavage site. For example, if the restriction enzyme used is MmeI, which cleaves 18 nucleotides downstream of its recognition site on the 3′-5′ strand (i.e., the bottom strand shown in the figures herein), then the recognition site is placed 16 nucleotide sequences upstream of the terminal nucleotide comprised by the double stranded region of the probe, in order to convert two nucleotides at the same time (see FIG. 3). Type IIS restriction enzymes with short distances between their recognition site and their cleavage site (e.g., 3 nucleotides) require that the restriction recognition sequence is close to the 3′ end of the double stranded portion of a probe. Conversely type IIS restriction enzymes with very long distances between their recognition and cleavage sites require that the recognition site is closer to the 5′ end of the double stranded portion of the probe and in some cases the length of X′ₓ/Xₓ may need to be expanded to ensure that the correct number of nucleotides are present between the recognition and cleavage sites. Thus, the Type IIS restriction enzyme utilized can affect the length of a probe required for the methods described herein.

The 5′ end of Xₓ further comprises a pre-specified target sequence that is identical to the pre-specified target sequence ligated to the target ssDNA molecule for the first round of conversion (see for example FIG. 2, wherein the bottom strand of the probe comprises a 5′-S′₁, S′₂, S′₃, S′₄, S′₅-3′ sequence and FIG. 1, wherein the target DNA comprises a 5′-S₁, S₂, S₃, S₄, S₅-3′ sequence). This permits binding of a second oligonucleotide probe in the second round and binding of additional oligonucleotide probes in each successive conversion round. It is important to note that a bound oligonucleotide is consumed during the process of conversion, thus for each successive round it is necessary to use a fresh aliquot of the probe library, enzyme mixtures and wash buffers. Probes can be synthesized by any means known to one of skill in the art, (e.g., an oligosynthesizer), or alternatively a probe library can be purchased from a commercial source such as IDT (available on the internet at idtdna.com), Invitrogen (Carlsbad, Calif.), etc.

For the purposes of converting a target ssDNA from its 5′ end, probes are synthesized with the following changes: (1) the first and second overhangs are interchanged so that the probe is in the correct orientation for converting the 5′ end, (2) the recognition site sequence of the type IIS restriction enzyme sequence is reversed (e.g., the recognition site is coded on the opposite strand; i.e., the 3′-5′ directional strand) such that at least one 5′ terminal nucleotide on a target ssDNA molecule is cleaved, and (3) the type IIS restriction enzyme recognition site is designed such that the appropriate number of nucleotides is present between the 3′ recognition site and the 5′ cleavage site for the desired restriction endonuclease.

In one embodiment, an additional probe (also referred to herein as an “elution probe”; not shown) is necessary following conversion if it is desired that the template is cleaved off of the structural support e.g., for further nanopore-based sequencing. For example, in one embodiment, the target ssDNA is initially tagged with a pre-specified sequence further comprising a type II restriction enzyme recognition site (see FIG. 3, M); however the single stranded nature of a target ssDNA molecule does not permit cleavage using a type II restriction enzyme. Thus, an additional single stranded probe is necessary to bind to the tagged region of a target ssDNA molecule to complete a double stranded recognition/cleavage site. Contact with an elution probe and further contacting the system with a desired type II restriction enzyme (e.g., BamHI) permits cleavage of the target ssDNA molecules from the support for further sequencing as desired.

It should be noted that in addition to the nucleotides A, C, T, and G, nucleotides in the 3′-end of the probe can be inosine (I) or other nucleotides that indiscriminately pair with adenine, thymine or cytosine. In this manner, the complexity of the library can be decreased permitting increased efficiency of conversion. Such positions should not be too close to the ligation site, otherwise they may interfere with the ligation reaction, however it can be as close as the 6th position from the ligation site (i.e., the 3′ end position of the probes illustrated in FIG. 3 and FIG. 4b can be an inosine). Having multiple inosine positions (e.g., the 6th, 7th, 8th and 9th positions) will not increase the library's complexity but will give a larger footprint for the ligase to work more efficiently.

One aspect of the methods described herein relates to an oligonucleotide probe library comprising T-shaped probes, which are useful for the methods of DNA conversion described herein.

### Level 2 Conversion Probes

There are two probe libraries useful in Level 2 conversion, referred to herein as Library I and Library II.

Library I comprises four distinct oligonucleotide probes (i.e., complexity of 4) corresponding to A, C, T and G. The probes comprise a double stranded portion P′/P, which is referred to herein as a “pre-specified nucleotide spacer sequence”. The “pre-specified nucleotide spacer sequence comprises at least three nucleotides but can vary in length at the discretion of one skilled in the art, taking into account such parameters as specific hybridization conditions, melting point, non-complementary sequences to probes of Library II etc. The probes of Library I comprise a first and second overhang, wherein the first single stranded overhang is complementary to the pre-specified nucleotide sequence on the target ssDNA and the second single stranded overhang is complementary to one end of a probe of Library II. For conversion on the 3′ end of a target molecule, the first single stranded overhang is on the 5′-3′ top strand, while the second single stranded overhang is on the 3′-5′ bottom strand.

FIG. 4a shows an exemplary probe of Library I, wherein P′ comprises on its 5′ end a sequence complementary to the pre-specified sequence attached to a target ssDNA molecule to be converted and a position that corresponds to A, C, T, or G (designated as n). In this example, the second single stranded overhang is on the 5′ end of P and comprises the invariant sequence 5′-q′₁, q′₂, q′₃, q′₄, q′₅-3′. In this example, the invariant sequence as defined herein comprises P, and the second single stranded overhang. In one embodiment, R′/R is within X′ₓ/Xₓ.

Library II comprises a probe similar to that used in Level I conversion. However, the first single stranded overhang sequence is designed to bind to the second single stranded overhang of probes in Library I, rather than direct binding to the target nucleic acid molecule. FIG. 4b shows an exemplary probe of Library II, wherein this sequence is 5′-q₅, q₄, q₃, q₂, q₁-3′. The probe comprises a double stranded portion, (R, X′ₓ/Xₓ, R), and a second single stranded overhang that binds to the end of the target ssDNA to be converted; these portions of the probe are designed in a manner similar to the probes used in Level 1 conversion. In addition, Library II further comprises a blocking oligonucleotide complementary to the first ssDNA overhang, wherein the 5′ end is unphosphorylated.

### Ligases

Ligation can be accomplished either enzymatically or chemically. Chemical ligation methods are well known in the art, e.g. Ferris et al, Nucleosides & Nucleotides, 8:407-414 (1989); Shabarova et al, Nucleic Acids Research, 19:4247-4251 (1991); and the like. Preferably, however, ligation is carried out enzymatically using a ligase in a standard protocol. Many ligases are known and are suitable for use in the invention, e.g. Lehman, Science, 186:790-797 (1974); Engler et al, DNA Ligases, pages 3-30 in Boyer, editor, The Enzymes, Vol. 15B (Academic Press, New York, 1982). Preferred ligases include T4 DNA ligase, T7 DNA ligase, E. coli DNA ligase, Taq ligase, Pfu ligase, and Tth ligase. Protocols for their use are well known, e.g. Sambrook et al; Barany, PCR Methods and Applications, 1:5-16 (1991); Marsh et al, Strategies, 5:73-76 (1992). Generally, ligases require that a 5′ phosphate group be present for ligation to the 3′ hydroxyl of an abutting strand.

A “ligase” as used herein refers to an enzyme that catalyzes the joining of a sugar-phosphate backbone of two nucleic acid sequences. Thus, a ligase joins the backbone of two independent DNA sequences to produce one seamless DNA sequence at that site. Two types of ligases can be utilized for the practice of the methods described herein: (a) RNA ligase (e.g, T4 RNA ligase), and (b) DNA ligase (e.g., T4 DNA ligase).

An RNA ligase (e.g., T4 RNA ligase), which also has activity on single stranded DNA, can be used to attach a pre-specified sequence tag to one end of a target ssDNA molecule. This sequence tag is necessary for hybridization with an oligonucleotide probe on the first round of conversion. Since most DNA ligases are active only on double stranded DNA molecules, the pre-specified sequence can be added to a single stranded DNA molecule by the use of an RNA ligase. This ligase is also useful for tagging a target RNA molecule for use with the methods described herein. The activity of this enzyme is lower on a single stranded DNA molecule than the activity on a single stranded RNA molecule, thus longer incubation times may be necessary for attaching a tag onto a target ssDNA molecule.

In an alternate embodiment, a DNA ligase is used to add the pre-specified nucleotide sequence to one end of a target ssDNA molecule followed by denaturation of the dsDNA to ssDNA, as described herein in the “Target nucleic acid templates” section.

The DNA ligase is also used herein to join one double stranded DNA fragment with an overhang, and one single stranded DNA fragment together and is useful for ligating an oligonucleotide probe to a target ssDNA molecule. Essentially, the target ssDNA and the oligonucleotide are ligated together to form a continuous circle comprising a double stranded portion at the probe region. This circle, produced by a ligated oligonucleotide probe and the target ssDNA molecule, is referred to herein as a “reaction circle” or a “target ssDNA/probe circle”.

In general, commercial ligases are derived from T4 bacteriophage or E. coli, however ligases from other sources are also contemplated. In one preferred embodiment, a thermostable ligase, such as Ampligase®, can be used. A thermostable ligase allows ligation under higher stringency temperatures, which can be tailored as necessary to permit specific hybridization of a distinct oligonucleotide probe.

Reaction conditions for commercial ligases can vary and methods for use are supplied by the manufacturer. These methods can be performed by one of skill in the art and changes to the reaction conditions to provide optimal performance of the ligase for the methods described herein are well within the abilities of one skilled in the art.

### Restriction Endonucleases

As used herein, the term “restriction enzyme digestion” of DNA refers to the catalytic cleavage of a DNA sequence with an enzyme that acts only at certain locations in the DNA (i.e., restriction endonucleases), and in general the sites for which each is specific is called a restriction site. The various restriction enzymes contemplated for use herein are commercially available and their reaction conditions, cofactors, and other requirements as established by the enzyme suppliers are used. Appropriate buffers and substrate amounts for particular restriction enzymes are specified by the manufacturer. Incubation for about 1 hour at 37° C. is ordinarily used, but may vary in accordance with the supplier's instructions. Two types of restriction endonucleases are useful in the practice of the methods described herein: (a) Type IIS and (b) Type II restriction endonucleases.

The type IIS restriction enzymes are used for cleavage of the terminal nucleotide of a target ssDNA molecule that is to be converted. Type IIS restriction enzymes (e.g., FokI, AlwI, MmeI) cleave outside of their recognition sequence to one side. These enzymes recognize sequences that are continuous and asymmetric. This cleavage pattern is achieved by two distinct domains on the enzyme, one for DNA binding, the other for DNA cleavage. They are thought to bind to DNA as monomers for the most part, but to cleave DNA cooperatively, through dimerization of the cleavage domains of adjacent enzyme molecules. An example of a Type IIS restriction enzyme is MmeI, that recognizes the asymmetric sequence TCCRAC and cleaves 20 nucleotides downstream on the 5′-3′ top strand, leaving a 3′ overhang of 2 nucleotides on the top strand. Type IIS restriction recognition sites are incorporated into a probe useful in the methods described herein.

Essentially almost any Type IIS restriction enzyme can be used in the methods described herein, including enzymes that leave behind a blunt end. It is important that a restriction enzyme with consistent cleavage properties is used in the methods described herein (e.g., specific cleavage site). In some instances only one nucleotide will be cleaved from the 3′ end of a target ssDNA molecule, thus an enzyme that does not cut consistently at its specific cleavage site will cause an error during conversion and any subsequent sequencing. It is also important to consider the length of time that a restriction enzyme takes for substantially complete cleavage. In one embodiment, a type IIS restriction enzyme is chosen that has a relatively short cleavage time, which permits successive rounds to occur in a relatively short time frame (e.g., to speed rate of conversion of a longer target ssDNA template). The type IIS restriction enzyme can be any recognized sequence of any type IIS restriction enzyme as defined by Roberts, R J, et al. (2003) Nucleic Acids Research 31(7):1805-1812, which is incorporated herein by reference in its entirety. In addition, it is contemplated herein that novel type IIS restriction enzymes that are (a) newly discovered in nature, (b) recombinantly produced, or (c) modified, can also be used with the methods described herein.

Some type IIS restriction enzymes are not useful for the methods described herein, and thus a type IIS restriction enzyme should be chosen with care. For example, some type IIS restriction enzymes cleave DNA on both sides of their recognition sequence (e.g., PsrI, PpiI, Hin41, AloI, BsaX, BcgI, CspCI, BaeI) and should be avoided in the methods described herein. It is possible to use these enzymes provided that the end of the target nucleic acid molecule that is not converted does not comprise a complete double stranded cleavage site.

In addition, some type IIS restriction enzymes have a cleavage site that requires a specific end nucleotide (e.g., Adenine) for cleavage instead of a degenerate nucleotide (e.g., n). Thus, these types of enzymes will only cleave target ssDNA molecules with this specific terminal nucleotide (e.g., Adenine) and therefore any target ssDNA molecules with other terminal nucleotides (e.g., Thymine, Cytosine, Guanidine) are not cleaved. Since the nucleotide sequence of a target ssDNA is unknown, it is not possible to use such enzymes for the process of conversion. Some examples of these enzymes include BsmI, BbvCI, BssSI, BseYI, Bpu10I, which are not contemplated for use herein.

Type II restriction enzymes are used in the methods described herein for the purpose of cleaving a converted ssDNA molecule from its solid support for further sequencing using, for example a nanopore-based technology. Some non-limiting type II enzymes are those such as HhaI, HindIII, BamHI and NotI that cleave DNA within their palindromic recognition sequences. Cleavage leaves a 3″-hydroxyl on one side of each cut and a 5″-phosphate on the other. Since the Type II restriction recognition site is attached to a target ssDNA molecule along with a pre-specified tag sequence, the region where the target ssDNA molecule is cleaved is consistent among all target ssDNA fragments. The target ssDNA molecule cannot be cleaved by a Type II restriction enzyme until a separate probe is added to complete the palindromic double stranded sequence. An elution probe designed for this purpose is contemplated and discussed herein.

### Hybridization Conditions

Nucleic acid hybridization involves contacting a probe with a target ssDNA under conditions where the probe and its complementary target ssDNA can form stable hybrid duplexes through complementary base pairing. The nucleic acids that do not form hybrid duplexes are then washed away leaving the hybridized oligonucleotides to be used in sequence preserved DNA conversion. Optimal hybridization conditions will vary with the length of probe and the stringency of conditions required for appropriate probe binding. In general, lower temperatures permit a larger number of probes to bind a target ssDNA (including non-specific probes), while higher temperatures permit a smaller number of probes to bind a target ssDNA due to an increase in stringency (e.g., only probes that specifically hybridize are permitted to bind a target ssDNA under stringent conditions).

General hybridization techniques are described in Hames and Higgins (1985) Nucleic Acid Hybridization, A Practical Approach, IRL Press; Gall and Pardue (1969) Proc. Natl. Acad. Sci. USA 63: 378-383; and John et al. (1969) Nature 223: 582-587. Methods of optimizing hybridization conditions are described, e.g., in Tijssen (1993) Laboratory Techniques in Biochemistry and Molecular Biology, Vol. 24: Hybridization With Nucleic Acid Probes, Elsevier, N.Y.). Conditions that promote annealing are known to those of skill in the art for DNA compositions and are described in Sambrook et al., (1989), Molecular Cloning: A Laboratory Manual, Second Edition, Cold Spring Harbor, N.Y.).

### Binary Code

In one embodiment of the methods described herein, a target ssDNA or target RNA molecule is converted to a binary code. In this embodiment, Xₓ comprises a first nucleic acid sequence X_{xI}, and a second nucleic acid sequence X_{xII}. The sequences of X_{xI} and X_{xII} are designed so that X_{xI} binds a molecular beacon having a first label, and X_{xII} binds a molecular beacon having a second, distinct label. X_{xI} and X_{xII} can range in size according to the needs of one skilled in the art, for example X_{xI} and X_{xII} can range from approximately 4 nucleotides to approximately 25 nucleotides each in length. In one embodiment, X_{xI} and X_{xII} are each 12 nucleotides in length.

Conversion of a target ssDNA into a binary code is based on a simple idea: each of the 4 different nucleotides constituting DNA molecules (i.e., A, T, C, G) or RNA molecules (i.e., A, U, C, G) is substituted with a 2-unit code, which are identified by “0” or “1” (see for example U.S. Pat. No. 6,723,513, which is incorporated herein in its entirety). For example, an adenine in the original sequence is substituted with a 2 unit code (0,0), a cytosine with (0,1), a guanine with (1,0), and thymine with (1,1). The binary code is a sequential concatenation of the 2 types of unit codes reflecting the base sequence of the original DNA molecule. In one embodiment, these unit codes are designed to be 4-25 bp-long DNA segments (i.e., 4, 5, 6, 7, 8, 9, 10, 11, 12, 13, 14, 15, 16, 17, 18, 19, 20, 21, 22, 23, 24, or 25). For example, the 0 unit code can be ATT TAT TAG G, and the 1 unit code can be CGG GCG GCA A, but any other sequence for the unit code can also be used. Notably this conversion results in e.g., an approximately 20-fold increase in DNA length, but single nucleotides no longer need to be resolved. Instead only the identity of the unit codes needs to be detected (0 or 1). This conversion thus greatly simplifies the readout process for single molecule (e.g., nanopore-based) sequencing.

Previous conversion of a double stranded target DNA molecule was performed with a biochemical conversion method developed by LingVitae AS (U.S. Pat. No. 6,723,513). However, the method of LingVitae is limited by the maximal length that is possible for a target DNA, utilizes double stranded DNA targets, and in some cases requires polymerases to amplify target DNA molecules. The method for conversion described herein is not limited by these constraints.

Exemplary Level 1 Method of Converting a Target ssDNA Molecule

A method is described herein for sequentially converting each nucleotide in a target ssDNA molecule into a converted ssDNA molecule, wherein each converted nucleotide is separated by a known sequence that represents that nucleotide. The known sequences are essentially a code comprising a pre-determined set of nucleotides, that represents each nucleotide. This code can be a binary code. In methods of the invention, the order of the target ssDNA sequence is preserved, however it is the known sequences that are used for further sequencing of the molecule rather than sequencing at single nucleotide resolution. For example, a converted adenine nucleotide is replaced with a 12-mer of known sequence derived from the oligonucleotide probe.

For illustration purposes an exemplary method is described below, wherein a target ssDNA molecule is tagged with a pre-specified sequence on the 5′ end, and the molecule is converted from the 3′ end. It is also contemplated herein that a target ssDNA molecule can be converted on its 5′ end, and the molecule is tagged on the 3′ end.

For the conversion method, a fragmented and immobilized single stranded target DNA molecule is contacted with a probe library under conditions that permit specific hybridization of a distinct probe (e.g., of 4⁷ distinct probes in a probe library, there will be one that specifically hybridizes to a target ssDNA; of that one distinct probe there can be e.g., thousands of copies). It is preferred that the overhang regions of a distinct probe specifically hybridize with 100% complementarity to a target ssDNA molecule to be converted. Following hybridization, excess probes that are not bound to a target ssDNA molecule are washed away with an appropriate wash buffer. In general, wash buffers comprise a buffered saline solution of a specific pH with an optimal detergent or salt component. Wash buffers with higher salt or detergent concentrations improve the stringency of washes and will remove non-specifically bound probes. The pH can also be raised or lowered to alter the wash stringency. Optimal conditions will vary with a particular wash buffer and is well within the ability of those skilled in the art to prepare and modify such a wash buffer.

The immobilized target ssDNA is then contacted with a ligase under conditions permissible for the ligation of a specifically hybridized probe to a target ssDNA such that a circle is formed, wherein the probe acts as a bridge between the two ends of a target ssDNA molecule. FIG. 3b depicts an example of ligating both ends of the shorter strand of the bound probe to the target ssDNA with a ligase, thus forming a circular molecule. The two spheres in FIG. 3b indicate the locations of ligation.

Following ligation, the ligation mixture is removed and is followed by a wash step.

The immobilized target ssDNA/probe circle is contacted with a Type IIS restriction enzyme (e.g., Mme1), which corresponds to the Type IIS restriction enzyme recognition site on the double stranded portion of a probe. The restriction enzyme cuts at a position several nucleotides away from its recognition site, such that at least one nucleotide (designated as x₁ in FIG. 3) is cleaved off of the 3′ end of the target ssDNA and remains attached to the nucleotide sequence designated as Xₓ in FIG. 3. The target ssDNA/probe complex is linearized during this process and a new 3′ end nucleotide is exposed.

FIG. 3c shows one embodiment of a cleavage step, wherein the ligated molecule is contacted with a type IIS restriction enzyme that specifically recognizes the sequence (R′/R) present in the double stranded DNA portion of the probe, wherein the enzyme cleaves at least one nucleotide on the 3′ end of the target ssDNA to be converted, thereby removing the nucleotide to be converted from the 3′ end of the target ssDNA molecule.

In order to remove the remaining bound probe and return the complex to a single stranded molecule, the system can be heated (e.g., 95° C.) and washed. Pieces of the linger strand of the probe are separated from the target ssDNA by heat and washed away; thus a probe cannot be re-used. One round of the conversion method is now complete. The 3′ end converted target ssDNA molecule in this example comprises on its' 5′ end, the 3′ converted nucleotide x, and Xₓ that comprises the 5′-S₁, S₂, S₃, S₄, S₅-3′ pre-specified sequence, and the remaining Xₓ sequence from the oligonucleotide probe. The remaining probe fragments and buffer mix are washed away.

The system can now be used for further rounds of conversion as desired. The second round proceeds similarly to the first. It is important to note that fresh solution aliquots are used for each successive round, for example a fresh aliquot of probes is used during the hybridization stage. In the second and subsequent repetitive rounds, an oligonucleotide probe distinct for the newly exposed 3′ and 5′ ends of a target ssDNA binds in a manner similar to the first probe. The first single stranded overhang binds to its complement on the 5′ end of the target ssDNA and the second single stranded overhang binds to the 3′ end of the target ssDNA. The system is incubated under conditions useful for hybridization, excess probe is washed away, and the system is contacted with a double stranded DNA ligase (e.g., T4 DNA ligase) to form a target ssDNA/probe circle. The system is washed again, and contacted with a Type IIS restriction enzyme (e.g., Mme1) to linearize the molecule and transfer the endmost 3′ nucleotide to the growing 5′ end. The system is heated to denature the double stranded region and the second round is complete. Further rounds proceed in a similar manner until the length of the conversion of essentially all of a target ssDNA fragment is complete (or conversion of a desired portion of a target ssDNA molecule is essentially complete).

It is also contemplated herein that multiple nucleotides are converted at the same time (e.g., at least 2, at least 3, at least 4, at least 5, at least 6, or more nucleotides are converted at one time). This does not change the complexity of the library, but will reduce the number of cycles for a given target. The restriction enzyme recognition site, R, is moved to the required distance from the cleavage site to permit cleavage of the desired number of nucleotides during each round of conversion.

The methods described herein are useful for converting, and subsequently sequencing, a target ssDNA molecule in less than one week. In one embodiment, the methods described herein can convert a target ssDNA molecule in less than one day (e.g., 16 hours, 12 hours, 8 hours, 4 hours, 2 hours, 1 hour, 30 minutes, 15 minutes, or any integer in between).

### Level 2 Method

In the basic method of DNA conversion described herein (called Level 1 conversion), it is possible for two independent probes to simultaneously bind to one target ssDNA molecule, wherein one probe binds the 5′ end and the second probe binds the 3′ end of the target ssDNA. This can result in reduced efficiency of sequencing. Thus, a more sophisticated method is also described herein and is referred to as “Level 2 DNA conversion”. This method also provides the advantage of adding a pre-specified nucleotide spacer sequence (e.g., a 12-mer) between each conversion cycle. This sequence can be used to hybridize a color-coded molecular beacon, different from the color beacons already used, to highly facilitate the read-out process and avoid potential frame shift errors.

Level 2 DNA conversion utilizes two probe libraries (e.g., FIG. 4), one of which comprises a blocking oligonucleotide (e.g., 5′-q₁′,q₂′,q₃′,q₄′,q₅′-3′). For the purposes of illustration the method is described herein for converting the 3′ end of a target ssDNA molecule, however it is also contemplated herein that a target ssDNA molecule can be converted from the 5′ end as well.

Library 1 comprises 4 distinct probes. An exemplary probe is shown in FIG. 4a that comprises a double-stranded region and a first and second single-stranded overhang, wherein the double stranded region is a pre-specified oligonucleotide spacer (P′/P); wherein the first single stranded overhang has the same composition as the first single-stranded overhang of probes in the library for Level 1 conversion (shown in FIG. 2). In this example, the first overhang has the sequence 5′-S′₅, S′₄, S′₃, S′₂, S′₁,n-3′ and the second single stranded overhang has a pre-specified sequence 5′-q′₁, q′₂, q′₃, q′₄, q′₅-3′, which is identical to the blocking oligonucleotide in Library II, and wherein the sequences of P′/P, 5′-q′₁,q′₂, q′₃, q′₄, q′₅-3″, and 5′-S′₅, S′₄, S′₃, S′₂, S′₁, n-3′ are chosen so that no two sequences or their complements can hybridize with each other with any appreciable strength.

One embodiment of Library II is shown in FIG. 4b, and comprises 4⁶ or 4096 distinct probes, each with a double stranded region and the first and second single-stranded overhangs. In this example, the double-stranded region has the same composition as the double-stranded region of the probes in the Level I conversion library (shown in FIG. 2), and has the sequence R′, X′ₓ/Xₓ, R, while the first single stranded overhang has e.g., the pre-specified sequence of 5′-q₅, q₄, q₃, q₂, q₁-3′, which is complementary to, and blocked by, the blocking oligonucleotide 5′-q₁′,q₂′,q₃′,q₄′,q₅′-3′. In this embodiment, the second single-stranded overhang has the same composition as the second single stranded overhang of the probes in the Level 1 conversion library and has the sequence (5′-x′,n,n,n,n,n-3′), wherein the 5′ end of the blocking oligonucleotide is unphosphorylated, which prevents it from being ligated with the 3′ end of R in the double stranded region by a ligase, wherein the 5′ end of the first single-stranded overhang can be unphosphorylated to prevent ligation, but this is not required.

For the particular application of nanopore sequencing, an invariant sequence (e.g., 5′-R, q′₁, q′₂, q′₃, q′₄, q′₅, P-3′) can be incorporated into the target ssDNA with each cycle of the conversion. This can be used to bind a unique molecule beacon, which serves as a “comma” between each converted base, such that it is positioned between each converted nucleotide (e.g., along with a binary code). If labeled to emit light in a third frequency, this beacon can be used to avoid a frame shift in the readout process (e.g., readout of a binary code), for the embodiment that the four oligonucleotide codes that correspond to A, C, G, and T are in the two bit format: X_{xI}, X_{xII} with X_{xI} and X_{xII} being two pre-specified sequences and each can be bound by a molecular beacon that is labeled to emit light in a specific frequency.

In one embodiment of this aspect and all other aspects disclosed herein, the 5′-S′₅, S′₄, S′₃, S′₂, S′₁-3′ sequence of the first single-stranded overhang of the library for Level I conversion, and the first single stranded overhang of Library I for Level II conversion, can have more than one pre-specified sequence. In one embodiment, 5′-S′₅, S′₄, S′₃, S′₂, S′₁-3′ can be four different pre-specified sequences, corresponding to A, C, G and T. In another embodiment, where the oligonucleotide codes are in the two-bit format (e.g., X_{xI},X_{xII}), 5′-S′₅, S′₄, S′₃, S′₂, S′₁-3′ can be two different pre-specified sequences, each corresponding to two types of nucleotides. These two embodiments would increase the complexity of the corresponding libraries by 4 and 2 fold, respectively.

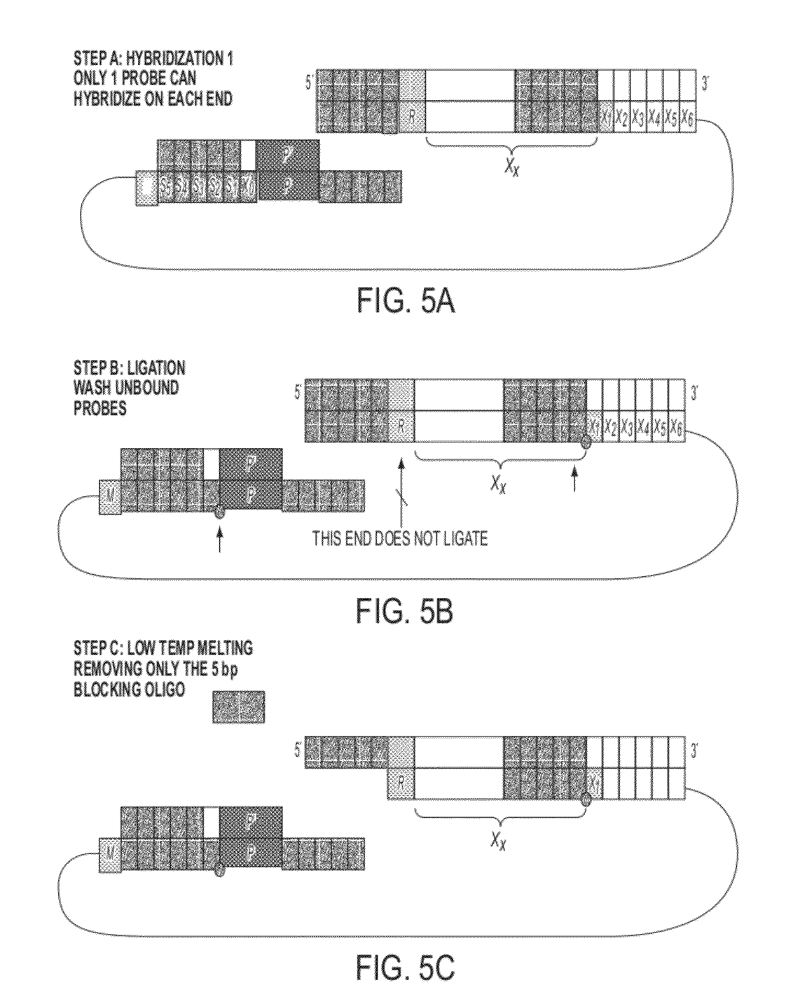

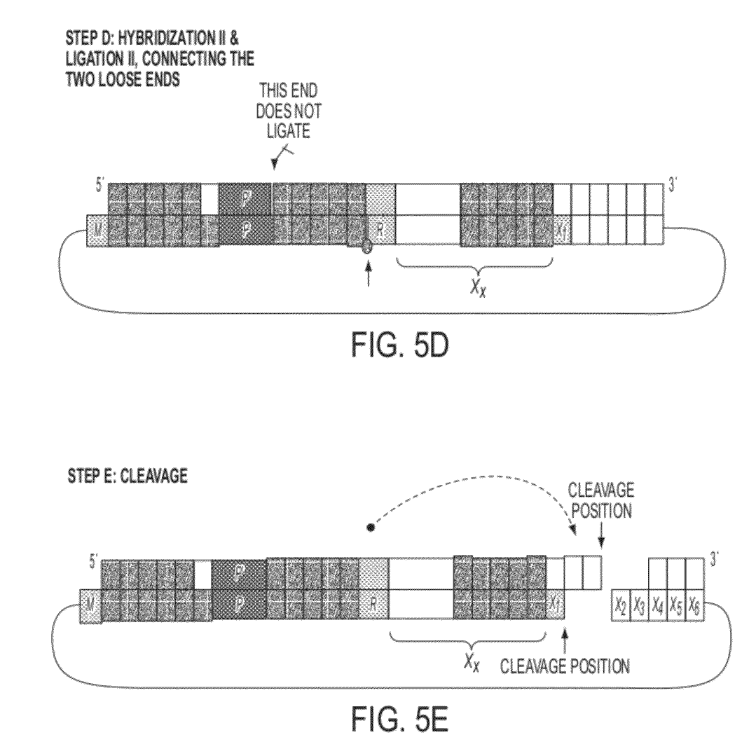

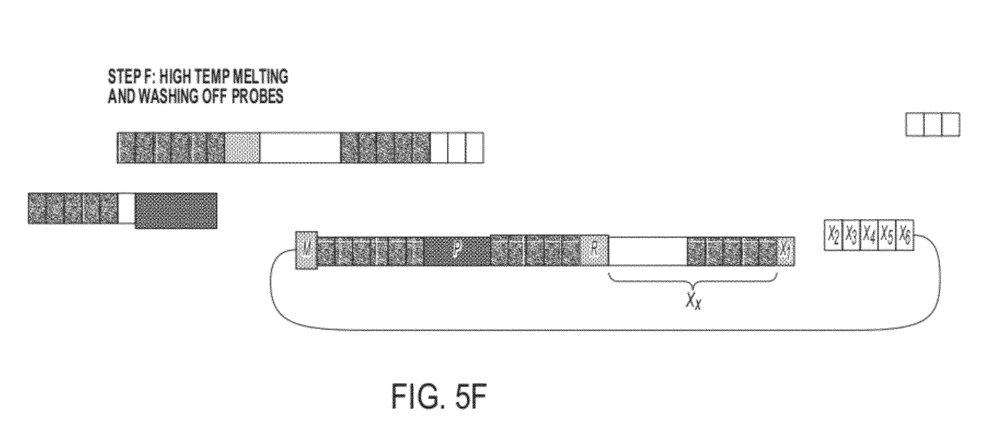

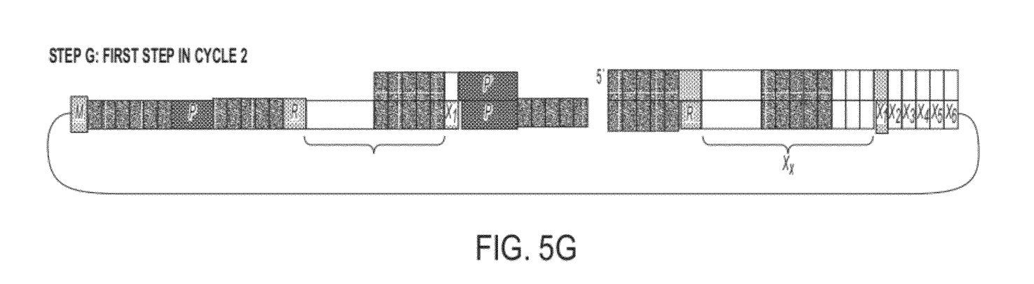

A schematic diagram representing one embodiment of a Level 2 conversion method is shown in FIG. 5. The exemplary method depicted in FIG. 5 comprises the following steps:

(a) a target ssDNA is prepared in the same manner as described above for Level 1 conversion, however it is contacted with a mixture of probes from Library I and Library II (FIG. 4), wherein only a probe in Library I with sequence complementary to the 5′ end of a target ssDNA molecule can hybridize to it and from a perfect duplex, wherein only a probe in Library II with sequence complementarity to the 3′ end of a target ssDNA molecule can hybridize to it and from a perfect duplex (FIG. 5a);

(b) ligating a Library I probe to the 5′ end of the target ssDNA and ligating a Library II probe to the 3′ end of the target ssDNA with a ligase, then washing away unbound probes (FIG. 5b);

(c) separating a blocking oligonucleotide (e.g., by low temperature melting) without separating other double stranded regions of the probe-target ssDNA complex, and washing away the blocking oligonucleotide (FIG. 5c);

(d) allowing the second single stranded overhang of a Library I probe to hybridize with the first single-stranded overhang of the Library II probe to form a perfect duplex (e.g., by cooling), and ligating the two probes with a ligase; thereby forming a circular molecule (FIG. 5d);

(e) cleaving the probe-target ssDNA with the type IIS restriction enzyme that specifically recognizes the sequence (R′/R); wherein the enzyme cleaves at the 5′ end of at least one nucleotide on the 3′ end of the target ssDNA to be converted (FIG. 5e);

(f) separating all double stranded regions (e.g., by high temperature melting) and washing away all portions of the probes that are not ligated to the target ssDNA (FIG. 5f); wherein steps (a)-(f) yield a converted target ssDNA molecule comprising, on its 5′ end, 5′-x₁, Xₓ₁, q′₁, q′₂, q′₃, q′₄, q′₅, P-3′, wherein Xₓ₁ is the pre-determined oligonucleotide code corresponding to the converted nucleotide of the target ssDNA (x₁ in FIG. 5).

In one embodiment of this aspect and all other aspects disclosed herein, steps (a)-(f) are repeated more than once. FIG. 5g illustrates step (a) of the second cycle.

It is important to note that Library I is not absolutely necessary for Level 2 conversion as described herein, i.e., Level 2 conversion can proceed with the library for Level 1 conversion and four blocking probes (e.g., 5′-A, S₁, S₂, S₃, S₄, S₅-3′, 5′-T, S₁, S₂, S₃, S₄, S₅-3′, 5′-C, S₁, S₂, S₃, S₄, S₅-3′, and 5′-G, S₁, S₂, S₃, S₄, S₅-3′) of which the 5′ ends are unphosphorylated.

Since a portion of the Library I probe is incorporated into a target ssDNA molecule upon conversion, it is important to consider the length of this incorporated region if nanopore-based sequencing is desired. Since the Library I probe can add e.g., 12 bases into the DNA molecule, the length of the molecular beacons may need to be extended to allow full quenching of one beacon by its neighboring beacon. In the absence of appropriate length molecular beacons, the signal-to-noise ratio can decrease. The ability to add a number of base pairs is contemplated herein for the design of different codes for representing a particular nucleotide in a converted molecule, and can therefore increase the applications of DNA conversion. Specifically this distinct sequence can be used to target a third color-coded molecular beacon, that marks a “comma” after each pair of code beacons in the converted DNA. This method can be used to avoid potential “frame shifts” in the readout process, since the third color will always mark the beginning of a new frame (or two color sequence of beacons), which corresponds to a certain nucleotide in the target DNA.

It is also contemplated herein that multiple nucleotides are converted at the same time (e.g., at least 2, at least 3, at least 4, at least 5, at least 6, or more nucleotides are converted at one time). This does not change the complexity of the library, but will reduce the number of cycles for a given target. The restriction enzyme recognition site, R, is moved to the required distance from the cleavage site to permit cleavage of the desired number of nucleotides during each round of conversion.

Cleavage of a Converted ssDNA Template Off of the Support

Once the target ssDNA molecule is converted, it is necessary in some embodiments to remove the immobilized molecule from its surface support so that it can be further sequenced using a nanopore sequencing system. For example, the pre-specified sequence is (5′-x₀, S₁, S₂, S₃, S₄, S₅, M-3′) and comprises a type II restriction enzyme that binds specifically to M and cleaves within this recognition sequence, thus releasing the target ssDNA that has been converted (see FIGS. 3 and 5).

The pre-specified sequence that is attached to the template molecule during preparation of the target ssDNA comprises a single strand of a double stranded, palindromic, restriction enzyme recognition sequence (e.g., Bam HI). A single stranded oligonucleotide comprising at least the complementary palindromic sequence of the pre-specified tag sequence is added to the target ssDNA fragments and incubated under conditions that permit specific hybridization. Preferably, the elution probe comprises a complementary palindromic sequence and at least a portion of a pre-specified tag sequence, such that the elution probe specifically hybridizes at the preferred site of cleavage, rather than at other regions in the target ssDNA molecule. The excess probe is washed away and the target ssDNA fragments with bound oligonucleotide probe are contacted with the restriction enzyme specific to the palindromic sequence present on the pre-specified sequence. The mobilized fragments can be collected for sequencing using a nanopore. If so desired, the process can be repeated to ensure complete elution of substantially all of the target ssDNA fragments from the support.

### Nanopore Sequencing

In one embodiment, a converted single-stranded nucleic acid is probed with a nanopore to permit rapid sequencing.

The concept of the nanopore-optical readout platform is described in detail in U.S. Pat. No. 6,362,002, which is incorporated herein by reference in its entirety. A target ssDNA is biochemically converted to a binary code, wherein each base in the original target ssDNA sequence is represented by a unique combination of 2 binary code units (0 and 1 labeled in open and solid circles, respectively). The converted target ssDNA is hybridized with 2 types of molecular beacons complementary to the 2 code units.

Molecular beacons are hairpin shaped molecules with an internally quenched fluorophore, whose fluorescence is restored when they bind to a complementary target nucleic acid sequence. The use of DNA hairpins as “molecular beacons” (Broude, “Stem-loop Oligonucleotides: a Robust Tool for Molecular Biology and Biotechnology,” Trends Biotechnol. 20:249-256 (2002)), either in solution (Tyagi et al., “Molecular Beacons: Probes that Fluoresce upon Hybridization,” Nature Biotech. 19:365-370 (2001); Dubertret et al., “Single-mismatch Detection Using Gold-quenched Fluorescent Oligonucleotides,” Nature Biotech. 19:365-370 (2001)) or immobilized on a solid surface (Fang et al., “Designing a Novel Molecular Bacon for Surface-Immobilized DNA Hybridization Studies,” J. Am. Chem. Soc. 121:2921-2922 (1999); Wang et al., “Label Free Hybridization Detection of Single Nucleotide Mismatch by Immobilization of Molecular Beacons on Agorose Film,” Nucl. Acids. Res. 30:61 (2002); Du et al., “Hybridization-based Unquenching of DNA Hairpins on Au Surfaces: Prototypical “Molecular Beacon” Biosensors,” J. Am. Chem. Soc. 125:4012:4013 (2003); Fan et al., “Electrochemical Interrogation of Conformational Changes as a Reagentless Method for the Sequence-specific Detection of DNA,” Proc. Natl. Acad. Sci. USA 100:9134-9137 (2003)), has proven to be a useful method for “label-free” detection of DNA fragments. Molecular beacons consist of DNA hairpins functionalized at one terminus with a fluorophore and at the other terminus with a quencher. In the absence of their complement, they exist in a closed, “dark” conformation. Hybridization occurs upon introduction of complementary oligonucleotides, which concomitantly forces open the hairpin and allows for a fluorescent, “bright” state.

Each of the beacons used in a nanopore-based sequencing method comprises a fluorophore on its 5′ end and a quencher at its 3′ end or vice versa, with each set of beacons comprising a distinguishing fluorophore (e.g., those that bind the 0 configuration, and those that bind the 1 configuration of the binary code comprise a distinct fluorophore). The broad-spectrum quencher molecule quenches both fluorophores (e.g., the quencher molecule prevents fluorescence of the stem loop molecular beacon, or it can hinder fluorescence of a neighboring molecular beacon even if the molecular beacon is bound to its complement). The 2 different color fluorophores make it possible to distinguish between the 2 beacons.

Generally, in solution the molecular beacons self-quench and upon hybridization to their targets, molecular beacons are designed to “light up” (Tyagi S, Kramer F R. Nat Biotech 1996; 14:303-8; Bonnet G, Tyagi S, Libchaber A, Kramer F R. Proc Natl Acad Sci USA 1999; 96:6171-66). However, in the nanopore-based sequencing method, molecular beacons are arranged such that the beacons are next to each other so that quenchers on neighboring beacons will quench the fluorescence emission of its neighboring beacon and the DNA will stay “dark” until individual code units are sequentially removed from the DNA (excluding the 1^{st} beacon). This concept is a key feature of the nanopore-optical readout method; it significantly reduces the fluorescence background from neighboring molecules and from free beacons in solution, resulting in a higher signal-to-background ratio (Meller A, Mathe' J, Eid J. USA, 2005). When the molecule is introduced to the nanopore, the beacons are stripped off sequentially one by one with a time delay of approximately 5-10 ms. This time is tuned by the electric field intensity to optimize the signal-to-background levels (Mathe' J, Visram H, Viasnoff V, Rabin Y, Meller A. Biophys J 2004; 87:3205-12; McNally, B., Wanunu, M., and Meller, A. Nano Letters 2008; 8:3418-3422). For example, each time a new beacon is removed, a new fluorophore is unquenched and registered by a custom-made microscope. By design, the released beacon is automatically closed, quenching its own fluorescence, whereupon it diffuses away from the vicinity of the pore. Immediately upon the release of the 1st beacon, its neighboring beacon's fluorophore will light up. The readout time is estimated (for a single pore) to be in the range of approximately 1 ms/base to 10 ms/base, or 100 units/s to 1000 units/s or any point between, for example 2, 3, 4, 5, 6, 7, 8, 9, or 10 ms/base or 150, 200, 250, 300, 350, 400, 500, 600, 750, 800, 900 or 1000 units/s.

In one embodiment, the molecular beacons may be attached to another molecule or chemical, which leads to an increased size, and the diameter of the nanopore can be greater than 2 nm, as long as it is small enough to remove the molecular beacons and the attached molecule or chemical, while permitting the ssDNA to pass through.

### Sequence Assembly of DNA Fragments

“Sequence assembly” refers to aligning and merging many fragments of a much longer DNA sequence in order to reconstruct the original sequence. Once the signal information has been accumulated through nanopore sequencing, a computer program can be used to assemble the sequence pieces into the original sequence of the target ssDNA molecule. Since the fragmentation of the template is random and independent for each genomic DNA molecule, the sequences of fragments from various genomic DNA molecules overlap. These overlapping regions can be added together using computational software, which analyzes the sequencing results for each fragment, detects overlapping regions between fragments derived from a region of genomic DNA and provides a highly probable sequence for the genomic DNA from the obtained sample.

Computational software for assembling or reconstructing a sequence from fragments can be obtained from a variety of sources. Some examples of DNA assembly software available on the worldwide web for use or purchase include, but are not limited to, Sequencher (genecodes.com), DNA baser aligner (dnabaser.com), CAP3 (pbil.univ_lyon1.fr.cap3.php; Huang, X. and Madan A. (1999) CAP3: A DNA sequence assembly program Genome Research 9:868-877), AMOS (jcvs.org/cms/research/software/#c614), TIGR assembler (jcvs.org/cms/research/software/#c614), Celera assembler (jcvs.org/cms/research/software/#c614), Phrap (phrap.org) or Clc bio Advanced contig assembly (cicbio.com). Methods for DNA sequence assembly from fragments are known to those of skill in the art.

### Sequencing Automation

In one embodiment, the process of conversion is performed using an automated system that can perform the wash steps, incubation steps and changes in temperature necessary for the conversion methods (e.g., an automated system can inject solutions, permit multiple conversion steps to be performed quickly, reduce contamination from outside DNA sources, and alter temperatures as entered e.g., into a computer program by a user). The system can include such components as a computer, an information storage device, robotic components, a temperature cycler, a microinjection system, buffer and enzyme solution storage etc. This type of system can be designed and used by one of skill in the art, and such a system is contemplated for use with the methods described herein.

As used in this specification and the appended claims, the singular forms “a,” “an,” and “the” include plural references unless the context clearly dictates otherwise. Thus for example, references to “the method” includes one or more methods, and/or steps of the type described herein and/or which will become apparent to those persons skilled in the art upon reading this disclosure and so forth.

It is understood that the foregoing detailed description and the following examples are illustrative only and are not to be taken as limitations upon the scope of the invention. Various changes and modifications to the disclosed embodiments, which will be apparent to those skilled in the art, may be made without departing from the spirit and scope of the present invention. Further, all patents, patent applications, and publications identified are expressly incorporated herein by reference for the purpose of describing and disclosing, for example, the methodologies described in such publications that might be used in connection with the present invention. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents are based on the information available to the applicants and do not constitute any admission as to the correctness of the dates or contents of these documents.

The present invention may be defined as any one of the following numbered paragraphs.

Paragraph 1: A method for converting a target single stranded DNA (ssDNA) molecule starting at its 3′ end, such that the nucleotides adenine (A), guanine (G), cytosine (C), or thymine (T) of the target ssDNA molecule are converted to a predetermined oligonucleotide code and that the order of the nucleotides of the target ssDNA is preserved during conversion, the method comprises the steps of: (a) contacting a target ssDNA having the pre-specified sequence 5′-x₀, S₁, S₂, S₃, S₄, S₅-3′ at its 5′-end, wherein x₀ can be A, C, G, or T and S₁, S₂, S₃, S₄, S₅ is the sequence in the first five positions of a predetermined oligonucleotide code (Xₓ), with a probe library comprising a plurality of oligonucleotide probes, wherein each probe comprises a double stranded DNA portion and a first and a second single-stranded overhang, wherein the double stranded DNA portion comprises a recognition sequence of a type IIS restriction enzyme (R′/R) and the predetermined oligonucleotide code (X′ₓ/Xₓ) that uniquely corresponds to the nucleotide to be converted (x) in the target ssDNA, wherein there is a type IIS restriction enzyme that can specifically bind to R′/R and cleave outside of said recognition sequence in said second single-stranded overhang, wherein the first single stranded overhang comprises the sequence 5′-S′₅, S′₄, S′₃, S′₂, S′₁ that is complementary to the sequence in the first five positions of the predetermined oligonucleotide code (5′-S₁, S₂, S₃, S₄, S₅-3′) followed by a position that is represented by all four nucleotides in the probe library (n); wherein the second single-stranded overhang having the sequence 5′-x′, n, n, n, n, n-3′ comprises a nucleotide (x′) that is complementary to the nucleotide to be converted (x) followed by five positions that are represented by all four nucleotides in the probe library, and wherein contacting is performed under conditions that permit one of a plurality of probes in the library to bind and form a perfectly matched duplex with the target ssDNA molecule, (b) ligating both ends of the shorter strand of the bound probe in step (a) to the target ssDNA with a ligase, thereby forming a circular molecule, (c) contacting the ligated molecule of step (b) with a type IIS restriction enzyme that specifically recognizes the sequence (R′/R) present in the double stranded DNA portion of a probe in step (a), wherein the enzyme cleaves at least one nucleotide on the 3′ end of the target molecule of the target ssDNA to be converted, thereby removing the nucleotide/s from the 3′ end of the target ssDNA molecule; and (d) separating the double stranded portion of the probe-target ssDNA complex that was cleaved in step (c) and washing away the oligonucleotides from the unligated strand of the probe; wherein steps (a)-(d) yield a converted target ssDNA molecule comprising on its 5′ end 5′-x, Xₓ, R-3′, wherein Xₓ is the pre-determined oligonucleotide code corresponding the converted nucleotide x, of the target ssDNA.

Paragraph 2: A method for converting a target single stranded DNA (ssDNA) molecule starting at its 3′ end such that the nucleotides adenine (A), guanine (G), cytosine (C), or thymine (T) of the target ssDNA molecule are converted to a predetermined oligonucleotide code, and that the order of the nucleotides of said target ssDNA is preserved during conversion, the method comprises the steps of: (a) contacting a target ssDNA molecule having a pre-specified nucleotide sequence on its 5′ end with an oligonucleotide probe library comprising a plurality of probes; wherein each probe comprises a double stranded DNA portion and a first and a second single stranded overhang, wherein the double stranded DNA portion comprises a 5′-3′ nucleotide sequence X′ₓ flanked by said first and second single stranded overhang, and a complementary 3′-5′ nucleotide sequence Xₓ that is complementary to the X′ₓ nucleotide sequence, wherein Xₓ comprises a predetermined oligonucleotide code that uniquely corresponds to a set order of nucleotides A, T, G or C, and represents the nucleotide to be converted; and wherein the double stranded portion of the probe contains a type IIS restriction enzyme recognition site (R), whose cleavage site is complete upon ligation of the probe to the 3′ end of said target ssDNA, of which at least one nucleotide is to be converted; wherein the first single stranded overhang is on the 5′ side of X′ and the second single stranded overhang is on the 3′ side of X′ₓ, wherein Xₓ comprises on its' 5′ end the pre-specified nucleotide sequence present on the 5′ end of the target ssDNA molecule; wherein the second single stranded overhang is on the 3′ end of X′ₓ and the first single stranded overhang precedes the 5′ end of X′ₓ; wherein the second single stranded overhang comprises a nucleotide, at a position immediately adjacent to the 3′ end of X′ₓ that is complementary to the nucleotide in said target ssDNA to be converted and further comprises at least 3 random nucleotides; and wherein the first single stranded overhang comprises at least one random nucleotide at a position immediately adjacent to the nucleotide at the 5′ end of X′ₓ, and further comprises a nucleotide sequence complementary to the pre-specified sequence present in the target ssDNA; and wherein said contacting is performed under conditions that permit one of the plurality of probes to bind and form a duplex with said target ssDNA molecule; (b) ligating both ends of the bound double stranded oligonucleotide of step (a) to said target ssDNA sequence, thereby forming a circular molecule; (c) contacting the ligated molecule of step (b) with a type IIS restriction enzyme corresponding to the type IIS restriction enzyme recognition site present in the double stranded DNA portion of step (a), wherein the type IIS restriction enzyme cleaves after at least one nucleotide on the 3′ end of the target ssDNA to be converted thereby removing the nucleotide/s to be converted from the 3′ end of the target ssDNA molecule; and (d) separating the double stranded portion of the ligated and cut probe of step (c) from the target ssDNA and washing away the unligated strand of the probe; wherein steps (a)-(d) yield a converted target ssDNA molecule comprising, on its 5′ end, the Xₓ predetermined oligonucleotide code corresponding to the converted nucleotide/s of the target ssDNA and wherein the Xₓ predetermined oligonucleotide code follows the converted nucleotide/s present on the 5′ end of the converted target ssDNA molecule.

Paragraph 3: A method for converting a target single stranded (ssDNA) target molecule starting at its' 5′ end such that the nucleotides adenine (A), guanine (G), cytosine (C), or thymine (T) of the ssDNA molecule are converted to a predetermined oligonucleotide code, and that the order of the nucleotides of the target ssDNA is preserved during conversion, the method comprising the steps of: (a) contacting a target ssDNA molecule having a pre-specified nucleotide sequence on its 3′ end with an oligonucleotide probe library comprising a plurality of probes; wherein each probe comprises a double stranded DNA portion and a first and second single stranded overhang, wherein the double stranded DNA portion comprises a 5′-3′ nucleotide sequence X′ₓ flanked by said first and second single stranded overhang, and a complementary 3′-5′ nucleotide sequence Xₓ that is complementary to the X′ₓ nucleotide sequence, wherein Xₓ comprises a predetermined oligonucleotide code that uniquely corresponds to a set order of nucleotides A, T, G or C, and represents the nucleotide to be converted; and wherein the double stranded portion of the probe contains a type IIS restriction enzyme recognition site (R), whose cleavage site is complete upon ligation of the probe to the 5′ end of said target ssDNA, of which at least one nucleotide is to be converted; wherein Xₓ comprises on its' 3′ end the pre-specified nucleotide sequence present on the 3′ end of the target ssDNA molecule; wherein the first single stranded overhang is on the 3′ side of X′ₓ and the second single stranded overhang is on the 5′ side of X′ₓ; wherein the second single stranded overhang comprises a nucleotide, at a position immediately adjacent to the nucleotide at the 5′ end of X′ₓ, that is complementary to the nucleotide in said target ssDNA to be converted and further comprises at least 3 random nucleotides; and wherein the first single stranded overhang comprises at least one random nucleotide at a position immediately adjacent to the nucleotide at the 3′ end of X′ₓ, and further comprises a nucleotide sequence complementary to the pre-specified sequence present in the target ssDNA; and wherein said contacting is performed under conditions that permit one of the plurality of double stranded oligonucleotides to bind to said target ssDNA molecule, thereby forming a circular molecule; (b) ligating the bound probe of step (a) to said target ssDNA sequence; (c) contacting the ligated molecule of step (b) with a type IIS restriction enzyme corresponding to the type IIS restriction enzyme recognition site present in the double stranded DNA portion of step (a), wherein the type IIS restriction enzyme cleaves after at least one nucleotide on the 5′ end of the target ssDNA to be converted thereby removing the nucleotide/s to be converted from the 5′ end of the target ssDNA molecule; and (d) separating the double stranded portion of the ligated and cut probe of step (c) from the target ssDNA and washing away the unligated strand of the probe; wherein steps (a)-(d) yield a converted target ssDNA molecule comprising, on it's 3′ end, the Xₓ predetermined oligonucleotide code corresponding to the converted nucleotide/s of the target ssDNA and wherein the Xₓ predetermined oligonucleotide code precedes the converted nucleotide/s present on the 3′ end of the converted target ssDNA molecule.

Paragraph 4: The method of paragraphs 1 to 3, wherein steps a-d are repeated more than once.

Paragraph 5: The method of paragraphs 1 to 4, wherein the target ssDNA molecule is immobilized on a solid support.

Paragraph 6: he method of paragraphs 1, 2, 4, or 5, wherein said pre-specified sequence on the target ssDNA molecule further comprises a restriction recognition site on its 3′ end.

Paragraph 7: The method of paragraphs 3 to 5, wherein said pre-specified sequence on the target ssDNA molecule further comprises a restriction recognition site on its 5′ end.

Paragraph 8: The method of paragraphs 1 to 7, wherein said pre-specified sequence, M, on said target ssDNA ranges from approximately 3 nucleotides to approximately 12 nucleotides.

Paragraph 9: The method of paragraphs 1 to 8, wherein said type IIS restriction enzyme is selected from the group consisting of: AlwI, BccI, BsmA1, EarI, MlyI, PleI, BmrI, BsaI, BsmB1, FauI, HpyAV, MnlI, SapI, BbsI, BciVI, HphI, MboII, BfuaI, BspMI, SfaNI, HgaI, BbvI, EciI, FokI, BceAI, BsmFI, BtgZI, BpmI, BpuEI, BsgI, AclWI, Alw26I, Bst6I, BstMAI, Eam1104I, Ksp632I, PpsI, SchI, BfiI, Bso31I, BspTNI, Eco31I, Esp3I, FauI, SmuI, BfuI, BpiI, BpuAI, BstV2I, AsuHPI, Acc36I, LweI, AarI, BseMII, TspDTI, TspGWI, BseXI, BstV1I, Eco57I, Eco57MI, GsuI, PsrI, and MmeI.

Paragraph 10: The method of paragraphs 1 to 9, wherein said type IIS restriction enzyme is MmeI.

Paragraph 11: The method of paragraphs 1 to 10, wherein Xₓ comprises a first nucleic acid sequence, X_{xI}, and a second nucleic acid sequence, X_{xII}, wherein X_{xI} and X_{xII} form a binary pre-specified oligonucleotide code which uniquely corresponds to either nucleotide A, T, G, or C.

Paragraph 12: The method of paragraphs 1 to 11, wherein X_{xI} and X_{xII} range from approximately 4 nucleotides to approximately 30 nucleotides each in length.

Paragraph 13: The method of paragraphs 1 to 12, wherein X_{xI} and X_{xII} are each 12 nucleotides in length.

Paragraph 14: The method of paragraphs 1 to 13, wherein said first overhang ranges from approximately 3 nucleotides to approximately 12 nucleotides in length.

Paragraph 15: The method of paragraphs 1 to 14, wherein said second overhang ranges from approximately 3 nucleotides to approximately 12 nucleotides in length.

Paragraph 16: The method of paragraphs 1 to 15, wherein said target ssDNA ranges from approximately 5 nucleotides to approximately 3,000,000 nucleotides in length.

Paragraph 17: The method of paragraphs 1 to 16, wherein a plurality of target ssDNA molecules are converted at the same time.

Paragraph 18: The method of paragraphs 1 to 17, wherein said conversion is performed on a sample comprising a heterogeneous mixture of target ssDNA nucleic acids.

Paragraph 19: The method of paragraphs 1 to 18, wherein a polymerase enzyme is not used at any step in said method.

Paragraph 20: The method of paragraphs 1 to 19, wherein said probe library has a complexity ranging from 16 to 1,048,576 distinct oligonucleotides.

Paragraph 21: The method of paragraphs 1 to 20, wherein said target ssDNA molecule is derived from a mammal.

Paragraph 22: The method of paragraph 21, wherein said mammal is a human.

Paragraph 23: The method of paragraphs 1 to 22 wherein said converted ssDNA molecule is sequenced at the single molecule level.

Paragraph 24: The method of paragraph 23, wherein said sequencing comprises a labeled molecular beacon.

Paragraph 25: The method of paragraph 24, wherein said labeled molecular beacon is a fluorescent molecular beacon.

Paragraph 26: The method of paragraph 25, wherein said fluorescent molecular beacon binds to an Xₓ sequence of said converted ssDNA molecule.

Paragraph 27: The method of paragraph 26, wherein said Xₓ sequence of said converted ssDNA molecule having a bound fluorescent molecular beacon is directed through a nanopore of diameter <2 nm, wherein the fluorescent molecular beacon is removed as the converted ssDNA molecule passes through said nanopore, wherein removal of said fluorescent molecular beacon produces a flash of light, wherein the order of light flashes yields the sequence of said target ssDNA sequence.

Paragraph 28: A method for converting a target single stranded DNA (ssDNA) molecule starting at its 3′ end such that the nucleotides adenine (A), guanine (G), cytosine (C), or thymine (T) of the target ssDNA molecule are converted to a predetermined oligonucleotide code, and that the order of the nucleotides of said target ssDNA is preserved during conversion, the method comprises the steps of: (a) contacting a target ssDNA molecule having a pre-specified nucleotide sequence on its 5′ end with a first probe library and a second probe library, wherein said contacting is performed under conditions that permit only one probe in said first library to hybridize to the 5′ end of the target ssDNA, and only one probe in said second probe library to hybridize to the 3′ end of the target ssDNA molecule; (b) ligating the hybridized probes of step (a) to said target ssDNA sequence; (c) exposing the ligated molecule of step (b) to a low melting temperature, thereby separating a blocking oligonucleotide from the ligated probe of said second probe library; (d) hybridizing the 3′ end of the ligated probe from said first probe library to the 5′ end of a ligated probe of said second probe library, thereby forming a circular molecule (e) contacting the ligated molecule of step (d) with a type IIS restriction enzyme, wherein the type IIS restriction enzyme cleaves after at least one nucleotide on the 3′ end of the target ssDNA to be converted thereby removing the nucleotide/s to be converted from the 3′ end of the target ssDNA molecule; and (f) separating the double stranded portion of each of the ligated and cut probes of step (e) from the target ssDNA and washing away the unligated strand of each probe; wherein steps (a)-(f) yield a converted target ssDNA molecule comprising, on its 5′ end, a predetermined oligonucleotide code of said probe from said second probe library corresponding to the converted nucleotide/s of the target ssDNA, and an invariant sequence of said probe from said first probe library, and wherein said predetermined oligonucleotide code precedes the converted nucleotide/s present on the 5′ end of the converted target ssDNA molecule.

Paragraph 29: A method for converting a target single stranded DNA (ssDNA) molecule starting at its 5′ end such that the nucleotides adenine (A), guanine (G), cytosine (C), or thymine (T) of the target ssDNA molecule are converted to a predetermined oligonucleotide code, and that the order of the nucleotides of said target ssDNA is preserved during conversion, the method comprises the steps of: (a) contacting a target ssDNA molecule having a pre-specified nucleotide sequence on its 3′ end with a first probe library and a second probe library, wherein said contacting is performed under conditions that permit only one probe in said first library to hybridize to the 3′ end of the target ssDNA, and only one probe in said second probe library to hybridize to the 5′ end of the target ssDNA molecule; (b) ligating the hybridized probes of step (a) to said target ssDNA sequence; (c) exposing the ligated molecule of step (b) to a low melting temperature, thereby separating a blocking oligonucleotide from a ligated probe of said second probe library; (d) hybridizing the 3′ end of a ligated probe from said first probe library to the 5′ end of a ligated probe of said second probe library, thereby forming a circular molecule (e) contacting the ligated molecule of step (d) with a type IIS restriction enzyme, wherein the type IIS restriction enzyme cleaves after at least one nucleotide on the 5′ end of the target ssDNA to be converted thereby removing the nucleotide/s to be converted from the 5′ end of the target ssDNA molecule; and (f) separating the double stranded portion of each of the ligated and cut probes of step (e) from the target ssDNA and washing away the unligated strand of each probe; wherein steps (a)-(f) yield a converted target ssDNA molecule comprising, on its 3′ end, a predetermined oligonucleotide code of said probe from said second probe library corresponding to the converted nucleotide/s of the target ssDNA, and an invariant sequence of said probe from said first probe library, and wherein said predetermined oligonucleotide code precedes the converted nucleotide/s present on the 3′ end of the converted target ssDNA molecule.

Paragraph 30: The method of paragraph 28, wherein said first probe library comprises a plurality of oligonucleotide probes consisting of four distinct oligonucleotide probes, each comprising a double stranded portion and a first and second single stranded overhang, wherein the double stranded portion comprises a pre-specified nucleotide spacer sequence (P′), and a sequence complimentary to said spacer sequence (P), wherein said first single stranded overhang comprises an A, T, G, or C at a position immediately adjacent to the 5′ end of P′ and a nucleotide complementary to the pre-specified sequence on the target ssDNA molecule, and wherein said second single stranded overhang comprises a second pre-specified nucleotide sequence identical to a blocking oligonucleotide of said second probe library and is positioned immediately adjacent to the 5′ end of P.

Paragraph 31: The method of paragraph 28 or 30, for converting a target single stranded DNA molecule starting at its 3′ end, the second probe library comprises a plurality of oligonucleotide probes, each probe comprising a double stranded portion and a first and second single stranded overhang, wherein the double stranded portion comprises a 5′-3′ nucleotide sequence X′ₓ flanked by said first and second single stranded overhangs and a complementary nucleotide sequence Xₓ, wherein Xₓ comprises a pre-determined oligonucleotide code that uniquely corresponds to a set order of nucleotides A, T , G, or C, wherein the double stranded portion of the probe also comprises a type IIS restriction enzyme recognition site whose corresponding cleavage site is complete upon ligation of the probe to at least one nucleotide on the end of the target ssDNA molecule which is to be converted, wherein X comprises on its 5′ end the pre-specified sequence present on said target ssDNA molecule; wherein said first single stranded overhang comprises a nucleotide sequence complementary to the pre-specified sequence present on said target ssDNA molecule; and wherein said second single stranded overhang comprises a nucleotide at a position immediately adjacent to the nucleotide at the 3′ end of X′ₓ that is complementary to the nucleotide in the target ssDNA to be converted and further comprises at least 3 random nucleotides, and wherein said second probe library further comprises a blocking oligonucleotide comprising a 3′-5′ sequence complementary to the first single stranded overhang, wherein the 5′ end of the blocking oligonucleotide and the 5′ end of the first single stranded overhang are unphosphorylated.

Paragraph 32: The method of paragraph 29, wherein said first probe library comprises a plurality of oligonucleotide probes consisting of four distinct oligonucleotide probes, each comprising a double stranded portion and a first and second single stranded overhang, wherein the double stranded portion comprises a pre-specified nucleotide spacer sequence (P′), and a sequence complimentary to said spacer sequence (P), wherein said first single stranded overhang comprises an A, T, G, or C at a position immediately adjacent to the 3′ end of P′ and a nucleotide complementary to the pre-specified sequence on the target ssDNA molecule, and wherein said second single stranded overhang comprises a second pre-specified nucleotide sequence identical to a blocking oligonucleotide of said second probe library and is positioned immediately adjacent to the 3′ end of P.

Paragraph 33: The method of paragraph 29 or 32, wherein said second probe library comprises a plurality of oligonucleotide probes, each probe comprising a double stranded portion and a first and second single stranded overhang, wherein the double stranded portion comprises a 5′-3′ nucleotide sequence X′ₓ flanked by said first and second single stranded overhangs and a complementary nucleotide sequence Xₓ, wherein Xₓ comprises a pre-determined oligonucleotide code that uniquely corresponds to a set order of nucleotides A, T , G, or C, wherein the double stranded portion of the probe also comprises a type IIS restriction enzyme recognition site whose corresponding cleavage site is complete upon ligation of the probe to at least one nucleotide on the end of the target ssDNA molecule which is to be converted, wherein X comprises on its 3′ end the pre-specified sequence present on said target ssDNA molecule; wherein said first single stranded overhang comprises a nucleotide sequence complementary to the pre-specified sequence present on said target ssDNA molecule; and wherein said second single stranded overhang comprises a nucleotide at a position immediately adjacent to the nucleotide at the 5′ end of X′ₓ that is complementary to the nucleotide in the target ssDNA to be converted and further comprises at least 3 random nucleotides, and wherein said second probe library further comprises a blocking oligonucleotide comprising a 3′-5′ sequence complementary to the first single stranded overhang, wherein the 5′ end of the blocking oligonucleotide and the 5′ end of the first single stranded overhang are unphosphorylated.

Paragraph 34: The method of paragraphs 28 to 33, wherein steps a-f are repeated more than once.

Paragraph 35: The method of paragraphs 28 to 34, wherein the target ssDNA molecule is immobilized on a solid support.

Paragraph 36: The method of paragraph 28, 30, 31, 34, or 35, wherein said pre-specified sequence on the target ssDNA molecule further comprises a restriction recognition site on its 3′ end.

Paragraph 37: The method of paragraph 29, 30, 33, 34 or 35, wherein said pre-specified sequence on the target ssDNA molecule further comprises a restriction recognition site on its 5′ end.

Paragraph 38: The method of paragraphs 28 to 37, wherein said pre-specified sequence on said target ssDNA ranges from approximately 3 nucleotides to approximately 12 nucleotides.

Paragraph 39: The method of paragraphs 28 to 38, wherein said type IIS restriction enzyme site is selected from the group consisting of: AlwI, BccI, BsmB1, EarI, MlyI, PleI, BmrI, BsaI, BsmB1, FauI, HpyAV, MnlI, SapI, BbsI, BciVI, HphI, MboII, BfuaI, BspMI, SfaNI, HgaI, BbvI, EciI, FokI, BceAI, BsmFI, BtgZI, BpmI, BpuEI, BsgI, AclWI, Alw26I, Bst6I, BstMAI, Eam1104I, Ksp632I, PpsI, SchI, BfiI, Bso31I, BspTNI, Eco31I, Esp3I, FauI, SmuI, BfuI, BpiI, BpuAI, BstV2I, AsuHPI, Acc36I, LweI, AarI, BseMII, TspDTI, TspGWI, BseXI, BstV1I, Eco57I, Eco57MI, GsuI, PsrI, or MmeI site.

Paragraph 40: The method of paragraphs 28 to 39, wherein said type IIS restriction enzyme site is an MmeI site.

Paragraph 41; The method of paragraphs 28 to 40, wherein Xₓ comprises a first nucleic acid sequence, X_{xI}, and a second nucleic acid sequence, X_{xII}, wherein X_{xI} and X_{xII} form a binary pre-specified oligonucleotide code which uniquely corresponds to either nucleotide A, T, G, or C.

Paragraph 42; The method of paragraphs 28 to 41, wherein X_{xI} and X_{xII} range from approximately 4 nucleotides to approximately 25 nucleotides each in length.

Paragraph 43: The method of paragraphs 28 to 42, wherein X_{xI} and X_{xII} are each 12 nucleotides in length.

Paragraph 44: The method of paragraphs 28 to 43, wherein said first overhang ranges from approximately 3 nucleotides to approximately 12 nucleotides in length.

Paragraph 45: The method of paragraphs 28 to 44, wherein said second overhang ranges from approximately 3 nucleotides to approximately 12 nucleotides in length.

Paragraph 46: The method of paragraphs 28 to 45, wherein said target ssDNA ranges from approximately 5 nucleotides to approximately 3,000,000 nucleotides in length.

Paragraph 47: The method of paragraphs 28 to 46, wherein a plurality of target ssDNA molecules are converted at the same time.

Paragraph 48: The method of paragraphs 28 to 47, wherein said conversion is performed on a sample comprising a heterogeneous mixture of target ssDNA nucleic acids.

Paragraph 49: The method of paragraphs 28 to 48, wherein a polymerase enzyme is not used at any step in said method.

Paragraph 50: The method of paragraphs 28 to 49, wherein said probe library has a complexity ranging from 16 to 1,048,576 distinct oligonucleotides.

Paragraph 51: The method of paragraphs 28 to 50, wherein said target ssDNA molecule is derived from a mammal.

Paragraph 52: The method of paragraph 49, wherein said mammal is a human.

Paragraph 53: The method of paragraphs 28 to 52, wherein said converted ssDNA molecule is sequenced at the single molecule level.

Paragraph 54: The method of paragraph 51, wherein said sequencing comprises a labeled molecular beacon.

Paragraph 55: The method of paragraph 54, wherein said labeled molecular beacon is a fluorescent molecular beacon.

Paragraph 56: The method of paragraph 55, wherein said fluorescent molecular beacon binds to an Xₓ sequence of said converted ssDNA molecule.

Paragraph 57: The method of paragraph 56, wherein said Xₓ sequence of said converted ssDNA molecule having a bound fluorescent molecular beacon is directed through a nanopore of diameter <2 nm, wherein the fluorescent molecular beacon is removed as the converted ssDNA molecule passes through said nanopore, wherein removal of said fluorescent molecular beacon produces a flash of light, wherein the order of light flashes yields the sequence of said target ssDNA sequence.

### EXAMPLES

### Example 1

### Circular DNA Conversion (CDC): Conversion of a Target ssDNA Target Molecule Starting at it's 5′ End

In this example (1) we show one base conversion (cytosine) to two bits (0,1) using a 100 base long DNA template (2) we show that by using ‘inosine’ for surrogate base pairing in the probe library, the probe library is reduced by an order of magnitude without loss of accuracy or yield of conversion and (3) We show high yield for 1 base conversion without using surface immobilization of templates or any micro fluidics approaches. Since the methods described herein are fully compatible with lab-on-a-chip techniques, these methods will increase the yield and efficiency of conversion by many orders of magnitude.

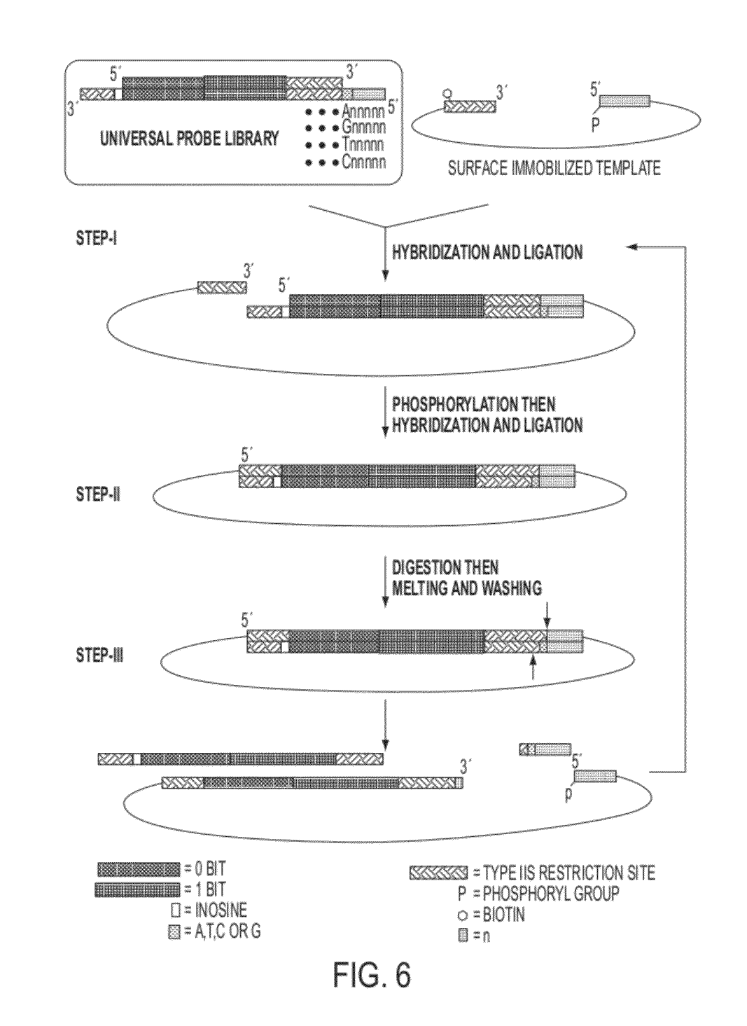

CDC Principle: A three-step process was used to convert nucleotides of template DNA to its corresponding 2-bit sequences, as illustrated in FIG. 6. Initially the template DNA was modified by phosphorylation at 5′ end and ligation to a 6 base biotinylated oligo corresponding to recognition site of a type IIS restriction enzyme at the 3′ end. This is a one-time modification step, which can be performed on thousands of different templates simultaneously, and is self-retained in all the subsequent conversion cycles. Template DNA was surface immobilized onto streptavidin coated magnetic beads with carefully chosen streptavidin concentration on the beads so as to avoid crowding of templates.

Universal probes used: Universal probes used are a set of four superset of the 2-bit combinations (2-bit combinations: (0,0), (0,1), (1,0) and (1,1)) with carefully chosen library of flanking sequences. The top primer (TP, 33mer) of the universal probe contains the desired sequences of 2-bit combination (red and blue regions) with the type IIS restriction site at 3′ end. Bottom primer (BP, 45 mer) contains the complementary sequences as well as 6 bases (5 bases corresponding to restriction site (denoted by brick style box) and 1 deoxyribose-Inosine (dI) base (denoted by blank box)) flanking at 3′ end. At the 5′ end a 13 base overhang which corresponds to the restriction site (7 bases), one specific nucleotide (A, T, G or C denoted by square speckled box) and 5 random nucleotides (m, denoted by wavy line box) is used. For each specific nucleotide next to the restriction site, the library contains all possible 4⁵ combinations of 5 nucleotides at the 5′ end. The total library size will be 4⁶ combinations of the 6 bases at the 5′ end of the bottom primers.

Successful Executions of Step I-Step III in Bulk:

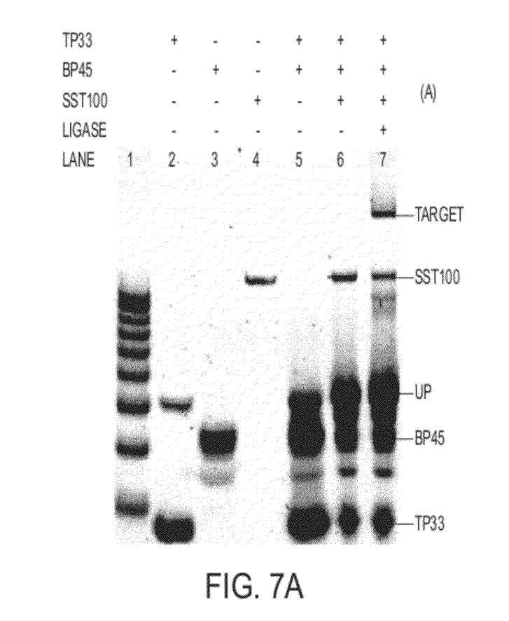

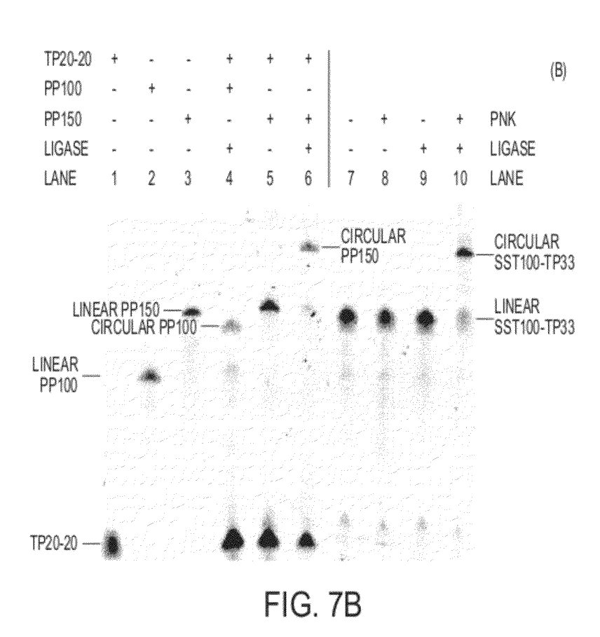

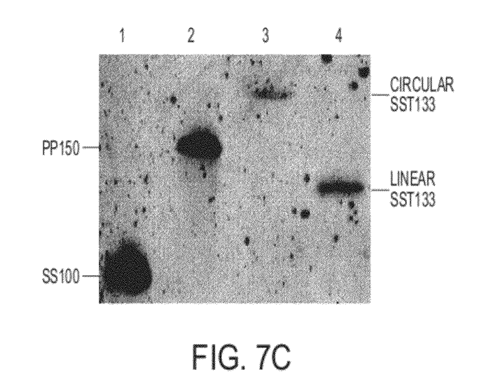

In Step-I, modified template DNA (100 bases ssDNA) was hybridized and ligated with a pool of the universal probes. Template DNA hybridizes and ligates only to the probes where the specific nucleotide of the universal probe complements to terminal nucleotide at the 5′ end of template. This selectivity of ligase enzyme for terminal complementation is exploited to achieve high specificity to pick out only the right universal probe from the library and the other non-specific probes are washed off. We found that by replacing 2 nucleotides with Inosine bases in the random 5 bases at 5′ of the bottom primer (in the form of “n-n-i-n-i”), we can reduced the library size from 4⁶ down to 4⁴ still achieving very high specificity, efficiency and yield. Templates at the 3′ end do not ligate to any probe as the 5′ end of the universal probes are not phosphorylated. This ensures no loss of template DNA occurs by ligation to non-specific universal probes (results are shown in FIG. 7A).

In Step-II, the 5′ of the selected probes were phosphorylated and ligated, to close the circles. The free 5′ end of top primer was phosphorylated using a T4-Polynucleotide Kinase (T4PNK) and then the ligase enzyme ligated the free 3′ end of template DNA onto the universal probes, thus circularizing the template DNA (FIG. 7B).

Finally in Step-III, digestion reaction with the Type IIS restriction enzyme followed by melting of dsDNA removed the bottom primer resulting in the release of terminal nucleotide from the 5′ end of template and ligation of a specifically selected probe with the appropriate 2-bits at its 3′ end. Restriction digestion enzyme left the 5′ end of the digest phosphorylated (FIG. 7C). After this step the template is ready again (without any further modifications) to go through the next cycle of conversion with the fresh buffer of universal probes as in Step-I.

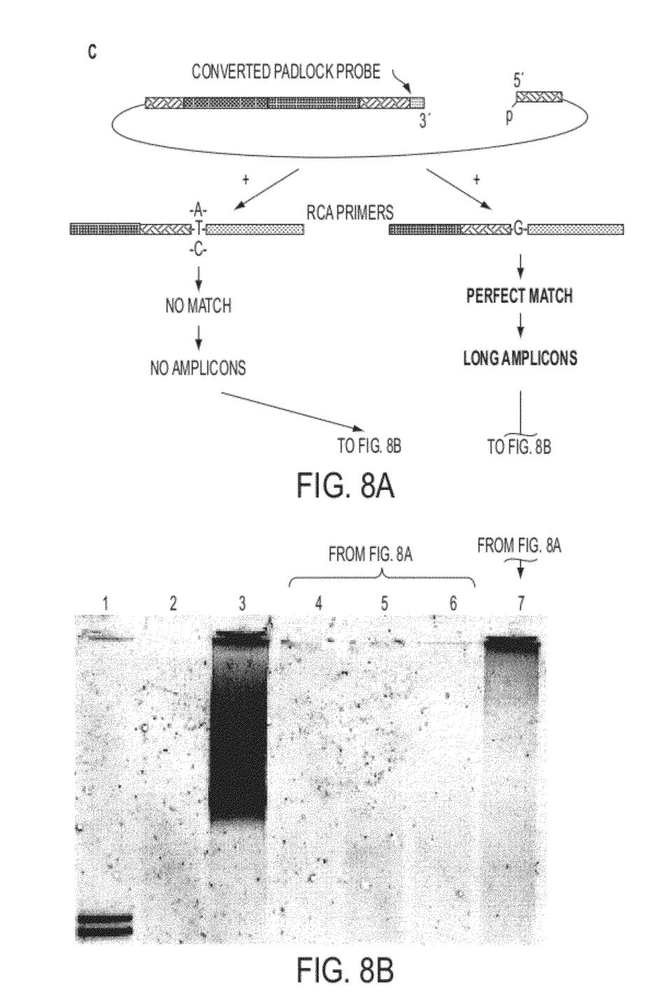

Proof of a correct CDC: We show a high yield conversion of a single cytosine base at the template DNA (FIG. 7), to its corresponding 2-bit sequence of (0, 1) and confirm it by Rolling Circle Amplification (RCA) assay. After completion of steps I-III the final product was split to 4 tubes and hybridized with 4 RCA primers which differ at only one base. Correct conversion of the terminal cytosine should result in a single stranded DNA template with the top primer (with the correct 2-bit sequence) ligated to the 3′ end of template capped with the terminal cytosine (FIG. 8A).

Rolling Circle Amplification (RCA) Test Assay: Four oligos with only one specific base difference were designed as primers to circularize the final product. 32 base sequence of the RCA primers contained from 5′ to 3′ end: 8 base complement to 1-bit sequence, 8 bases complement to the restriction enzyme recognition site, 1 specific base (A, T, G or C) and 15 bases complement to the 5′ sequence after the terminal cytosine of the original 100 base template. The four RCA primers, with 1 base difference at the center, were individually mixed with the final product of CDC conversion and ligation and amplification was performed with ligase and a processive Phi29 DNA polymerase. RCA is very sensitive to the terminal base identity for amplification and hence used here as a stringent test for our conversion method. As seen in the 0.8% Agarose gel in FIG. 8B, only the primer with the correct specific base at the centre resulted in amplified DNA, thus providing us with unequivocal proof of cytosine conversion by our three-step CDC conversion method. As a control experiment, primer TP20-20 which is perfectly complement to the control template TP150 when mixed with DNA polymerase shows amplification in presence of ligase (lane 3) and no amplification products (lane 2) in absence of template circularization by the ligase enzyme.

1. A method for converting a target single stranded DNA (ssDNA) molecule starting at its 3′ end, such that the nucleotides adenine (A), guanine (G), cytosine (C), or thymine (T) of the target ssDNA molecule are converted to a predetermined oligonucleotide code and that the order of the nucleotides of the target ssDNA is preserved during conversion, the method comprises the steps of:
(a) contacting a target ssDNA having the pre-specified sequence 5′-x₀, S₁, S₂, S₃, S₄, S₅-3′ at its 5′-end, wherein x₀ can be A, C, G, or T and S₁, S₂, S₃, S₄, S₅ is the sequence in the first five positions of a predetermined oligonucleotide code (Xₓ), with a probe library comprising a plurality of oligonucleotide probes, wherein each probe comprises a double stranded DNA portion and a first and a second single-stranded overhang, wherein the double stranded DNA portion comprises a recognition sequence of a type IIS restriction enzyme (R′/R) and the predetermined oligonucleotide code (X′ₓ/Xₓ) that uniquely corresponds to the nucleotide to be converted (x) in the target ssDNA, wherein there is a type IIS restriction enzyme that can specifically bind to R′/R and cleave outside of said recognition sequence in said second single-stranded overhang, wherein the first single stranded overhang comprises the sequence 5′-S′₅, S′₄, S′₃, S′₂, S′₁ that is complementary to the sequence in the first five positions of the predetermined oligonucleotide code (5′-S₁, S₂, S₃, S₄, S₅-3′) followed by a position that is represented by all four nucleotides in the probe library (n); wherein the second single-stranded overhang having the sequence 5′-x, n, n, n, n, n-3′ comprises a nucleotide (x′) that is complementary to the nucleotide to be converted (x) followed by five positions that are represented by all four nucleotides in the probe library, and wherein contacting is performed under conditions that permit one of a plurality of probes in the library to bind and form a perfectly matched duplex with the target ssDNA molecule,
(b) ligating both ends of the shorter strand of the bound probe in step (a) to the target ssDNA with a ligase, thereby forming a circular molecule,
(c) contacting the ligated molecule of step (b) with a type IIS restriction enzyme that specifically recognizes the sequence (R′/R) present in the double stranded DNA portion of a probe in step (a), wherein the enzyme cleaves at least one nucleotide on the 3′ end of the target molecule of the target ssDNA to be converted, thereby removing the nucleotide/s from the 3′ end of the target ssDNA molecule; and
(d) separating the double stranded portion of the probe-target ssDNA complex that was cleaved in step (c) and washing away the oligonucleotides from the unligated strand of the probe; wherein steps (a)-(d) yield a converted target ssDNA molecule comprising on its 5′ end 5′-x, Xₓ, R-3′, wherein Xₓ is the pre-determined oligonucleotide code corresponding the converted nucleotide x, of the target ssDNA.

2. A method for converting a target single stranded DNA (ssDNA) molecule starting at its 3′ end such that the nucleotides adenine (A), guanine (G), cytosine (C), or thymine (T) of the target ssDNA molecule are converted to a predetermined oligonucleotide code, and that the order of the nucleotides of said target ssDNA is preserved during conversion, the method comprises the steps of:
(a) contacting a target ssDNA molecule having a pre-specified nucleotide sequence on its 5′ end with an oligonucleotide probe library comprising a plurality of probes; wherein each probe comprises a double stranded DNA portion and a first and a second single stranded overhang, wherein the double stranded DNA portion comprises a 5′-3′ nucleotide sequence X′ₓ flanked by said first and second single stranded overhang, and a complementary 3′-5′ nucleotide sequence Xₓ that is complementary to the X′ₓ nucleotide sequence, wherein Xₓ comprises a predetermined oligonucleotide code that uniquely corresponds to a set order of nucleotides A, T, G or C, and represents the nucleotide to be converted; and wherein the double stranded portion of the probe contains a type IIS restriction enzyme recognition site (R), whose cleavage site is complete upon ligation of the probe to the 3′ end of said target ssDNA, of which at least one nucleotide is to be converted; wherein the first single stranded overhang is on the 5′ side of X′ₓ and the second single stranded overhang is on the 3′ side of X′ₓ, wherein Xₓ comprises on its' 5′ end the pre-specified nucleotide sequence present on the 5′ end of the target ssDNA molecule; wherein the second single stranded overhang is on the 3′ end of X′ₓ and the first single stranded overhang precedes the 5′ end of X′ₓ; wherein the second single stranded overhang comprises a nucleotide, at a position immediately adjacent to the 3′ end of X′ₓ, that is complementary to the nucleotide in said target ssDNA to be converted and further comprises at least 3 random nucleotides; and wherein the first single stranded overhang comprises at least one random nucleotide at a position immediately adjacent to the nucleotide at the 5′ end of X′ₓ, and further comprises a nucleotide sequence complementary to the pre-specified sequence present in the target ssDNA; and wherein said contacting is performed under conditions that permit one of the plurality of probes to bind and form a duplex with said target ssDNA molecule;
(b) ligating both ends of the bound double stranded oligonucleotide of step (a) to said target ssDNA sequence, thereby forming a circular molecule;
(c) contacting the ligated molecule of step (b) with a type IIS restriction enzyme corresponding to the type IIS restriction enzyme recognition site present in the double stranded DNA portion of step (a), wherein the type IIS restriction enzyme cleaves after at least one nucleotide on the 3′ end of the target ssDNA to be converted thereby removing the nucleotide/s to be converted from the 3′ end of the target ssDNA molecule; and
(d) separating the double stranded portion of the ligated and cut probe of step (c) from the target ssDNA and washing away the unligated strand of the probe;
wherein steps (a)-(d) yield a converted target ssDNA molecule comprising, on its 5′ end, the Xₓ predetermined oligonucleotide code corresponding to the converted nucleotide/s of the target ssDNA and wherein the Xₓ predetermined oligonucleotide code follows the converted nucleotide/s present on the 5′ end of the converted target ssDNA molecule.

3. A method for converting a target single stranded (ssDNA) target molecule starting at its' 5′ end such that the nucleotides adenine (A), guanine (G), cytosine (C), or thymine (T) of the ssDNA molecule are converted to a predetermined oligonucleotide code, and that the order of the nucleotides of the target ssDNA is preserved during conversion, the method comprising the steps of:
(a) contacting a target ssDNA molecule having a pre-specified nucleotide sequence on its 3′ end with an oligonucleotide probe library comprising a plurality of probes; wherein each probe comprises a double stranded DNA portion and a first and second single stranded overhang, wherein the double stranded DNA portion comprises a 5′-3′ nucleotide sequence X′ₓ flanked by said first and second single stranded overhang, and a complementary 3′-5′ nucleotide sequence Xₓ that is complementary to the X′ₓ nucleotide sequence, wherein Xₓ comprises a predetermined oligonucleotide code that uniquely corresponds to a set order of nucleotides A, T, G or C, and represents the nucleotide to be converted; and wherein the double stranded portion of the probe contains a type IIS restriction enzyme recognition site (R), whose cleavage site is complete upon ligation of the probe to the 5′ end of said target ssDNA, of which at least one nucleotide is to be converted; wherein Xₓ comprises on its' 3′ end the pre-specified nucleotide sequence present on the 3′ end of the target ssDNA molecule; wherein the first single stranded overhang is on the 3′ side of X′ₓ and the second single stranded overhang is on the 5′ side of X′ₓ; wherein the second single stranded overhang comprises a nucleotide, at a position immediately adjacent to the nucleotide at the 5′ end of X′ₓ, that is complementary to the nucleotide in said target ssDNA to be converted and further comprises at least 3 random nucleotides; and wherein the first single stranded overhang comprises at least one random nucleotide at a position immediately adjacent to the nucleotide at the 3′ end of X′ₓ, and further comprises a nucleotide sequence complementary to the pre-specified sequence present in the target ssDNA; and wherein said contacting is performed under conditions that permit one of the plurality of double stranded oligonucleotides to bind to said target ssDNA molecule, thereby forming a circular molecule;
(b) ligating the bound probe of step (a) to said target ssDNA sequence;
(c) contacting the ligated molecule of step (b) with a type IIS restriction enzyme corresponding to the type IIS restriction enzyme recognition site present in the double stranded DNA portion of step (a), wherein the type IIS restriction enzyme cleaves after at least one nucleotide on the 5′ end of the target ssDNA to be converted thereby removing the nucleotide/s to be converted from the 5′ end of the target ssDNA molecule; and
(d) separating the double stranded portion of the ligated and cut probe of step (c) from the target ssDNA and washing away the unligated strand of the probe;
wherein steps (a)-(d) yield a converted target ssDNA molecule comprising, on it's 3′ end, the Xₓ predetermined oligonucleotide code corresponding to the converted nucleotide/s of the target ssDNA and wherein the Xₓ predetermined oligonucleotide code precedes the converted nucleotide/s present on the 3′ end of the converted target ssDNA molecule.

4. The method of claim 1, wherein steps a-d are repeated more than once.

5. The method of claim 1, wherein the target ssDNA molecule is immobilized on a solid support.

6. The method of claim 1, wherein said pre-specified sequence on the target ssDNA molecule further comprises a restriction recognition site on its 3′ end.

7. The method of claim 3, wherein said pre-specified sequence on the target ssDNA molecule further comprises a restriction recognition site on its 5′ end.

8. The method of claim 1, wherein said pre-specified sequence, M, on said target ssDNA ranges from approximately 3 nucleotides to approximately 12 nucleotides.

9. The method of claim 1, wherein said type IIS restriction enzyme is selected from the group consisting of: AlwI, BccI, BsmA1, EarI, MlyI, PleI, BmrI, BsaI, BsmB1, FauI, HpyAV, MnlI, SapI, BbsI, BciVI, HphI, MboII, BfuaI, BspMI, SfaNI, HgaI, BbvI, EciI, FokI, BceAI, BsmFI, BtgZI, BpmI, BpuEI, BsgI, AclWI, Alw26I, Bst6I, BstMAI, Eam1104I, Ksp632I, PpsI, SchI, BfiI, Bso31I, BspTNI, Eco31I, Esp3I, FauI, SmuI, BfuI, BpiI, BpuAI, BstV2I, AsuHPI, Acc36I, LweI, AarI, BseMII, TspDTI, TspGWI, BseXI, BstV1I, Eco57I, Eco57MI, GsuI, PsrI, and MmeI.

10. The method of claim 1, wherein said type IIS restriction enzyme is MmeI.

11. The method of claim 1, wherein Xₓ comprises a first nucleic acid sequence, X_{xI}, and a second nucleic acid sequence, X_{xII}, wherein X_{xI} and X_{xII} form a binary pre-specified oligonucleotide code which uniquely corresponds to either nucleotide A, T, G, or C.

12. The method of claim 1, wherein X_{xI} and X_{xII} range from approximately 4 nucleotides to approximately 30 nucleotides each in length.

13. The method of claim 1, wherein X_{I} and X_{xII} are each 12 nucleotides in length.

14. The method of claim 1, wherein said first overhang ranges from approximately 3 nucleotides to approximately 12 nucleotides in length.

15. The method of claim 1, wherein said second overhang ranges from approximately 3 nucleotides to approximately 12 nucleotides in length.

16. The method of claim 1, wherein said target ssDNA ranges from approximately 5 nucleotides to approximately 3,000,000 nucleotides in length.

17. The method of claim 1, wherein a plurality of target ssDNA molecules are converted at the same time.

18. The method of claim 1, wherein said conversion is performed on a sample comprising a heterogeneous mixture of target ssDNA nucleic acids.

19. The method of claim 1, wherein a polymerase enzyme is not used at any step in said method.

20. The method of claim 1, wherein said probe library has a complexity ranging from 16 to 1,048,576 distinct oligonucleotides.

21. The method of claim 1, wherein said target ssDNA molecule is derived from a mammal.

22. The method of claim 21, wherein said mammal is a human.

23. The method of claim 1, wherein said converted ssDNA molecule is sequenced at the single molecule level.

24. The method of claim 23, wherein said sequencing comprises a labeled molecular beacon.

25. The method of claim 24, wherein said labeled molecular beacon is a fluorescent molecular beacon.

26. The method of claim 25, wherein said fluorescent molecular beacon binds to an Xₓ sequence of said converted ssDNA molecule.

27. The method of claim 26, wherein said Xₓ sequence of said converted ssDNA molecule having a bound fluorescent molecular beacon is directed through a nanopore of diameter <2 nm, wherein the fluorescent molecular beacon is removed as the converted ssDNA molecule passes through said nanopore, wherein removal of said fluorescent molecular beacon produces a flash of light, wherein the order of light flashes yields the sequence of said target ssDNA sequence.

28. A method for converting a target single stranded DNA (ssDNA) molecule starting at its 3′ end such that the nucleotides adenine (A), guanine (G), cytosine (C), or thymine (T) of the target ssDNA molecule are converted to a predetermined oligonucleotide code, and that the order of the nucleotides of said target ssDNA is preserved during conversion, the method comprises the steps of:
(a) contacting a target ssDNA molecule having a pre-specified nucleotide sequence on its 5′ end with a first probe library and a second probe library, wherein said contacting is performed under conditions that permit only one probe in said first library to hybridize to the 5′ end of the target ssDNA, and only one probe in said second probe library to hybridize to the 3′ end of the target ssDNA molecule;
(b) ligating the hybridized probes of step (a) to said target ssDNA sequence;
(c) exposing the ligated molecule of step (b) to a low melting temperature, thereby separating a blocking oligonucleotide from the ligated probe of said second probe library;
(d) hybridizing the 3′ end of the ligated probe from said first probe library to the 5′ end of a ligated probe of said second probe library, thereby forming a circular molecule;
(e) contacting the ligated molecule of step (d) with a type IIS restriction enzyme, wherein the type IIS restriction enzyme cleaves after at least one nucleotide on the 3′ end of the target ssDNA to be converted thereby removing the nucleotide/s to be converted from the 3′ end of the target ssDNA molecule; and
(f) separating the double stranded portion of each of the ligated and cut probes of step (e) from the target ssDNA and washing away the unligated strand of each probe;
wherein steps (a)-(f) yield a converted target ssDNA molecule comprising, on its 5′ end, a predetermined oligonucleotide code of said probe from said second probe library corresponding to the converted nucleotide/s of the target ssDNA, and an invariant sequence of said probe from said first probe library, and wherein said predetermined oligonucleotide code precedes the converted nucleotide/s present on the 5′ end of the converted target ssDNA molecule.

29. A method for converting a target single stranded DNA (ssDNA) molecule starting at its 5′ end such that the nucleotides adenine (A), guanine (G), cytosine (C), or thymine (T) of the target ssDNA molecule are converted to a predetermined oligonucleotide code, and that the order of the nucleotides of said target ssDNA is preserved during conversion, the method comprises the steps of:
(a) contacting a target ssDNA molecule having a pre-specified nucleotide sequence on its 3′ end with a first probe library and a second probe library, wherein said contacting is performed under conditions that permit only one probe in said first library to hybridize to the 3′ end of the target ssDNA, and only one probe in said second probe library to hybridize to the 5′ end of the target ssDNA molecule;
(b) ligating the hybridized probes of step (a) to said target ssDNA sequence;
(c) exposing the ligated molecule of step (b) to a low melting temperature, thereby separating a blocking oligonucleotide from a ligated probe of said second probe library;
(d) hybridizing the 3′ end of a ligated probe from said first probe library to the 5′ end of a ligated probe of said second probe library, thereby forming a circular molecule.
(e) contacting the ligated molecule of step (d) with a type IIS restriction enzyme, wherein the type IIS restriction enzyme cleaves after at least one nucleotide on the 5′ end of the target ssDNA to be converted thereby removing the nucleotide/s to be converted from the 5′ end of the target ssDNA molecule; and
(f) separating the double stranded portion of each of the ligated and cut probes of step (e) from the target ssDNA and washing away the unligated strand of each probe;
wherein steps (a)-(f) yield a converted target ssDNA molecule comprising, on its 3′ end, a predetermined oligonucleotide code of said probe from said second probe library corresponding to the converted nucleotide/s of the target ssDNA, and an invariant sequence of said probe from said first probe library, and wherein said predetermined oligonucleotide code precedes the converted nucleotide/s present on the 3′ end of the converted target ssDNA molecule.

30. The method of claim 28, wherein said first probe library comprises a plurality of oligonucleotide probes consisting of four distinct oligonucleotide probes, each comprising a double stranded portion and a first and second single stranded overhang, wherein the double stranded portion comprises a pre-specified nucleotide spacer sequence (P′), and a sequence complimentary to said spacer sequence (P), wherein said first single stranded overhang comprises an A, T, G, or C at a position immediately adjacent to the 5′ end of P′ and a nucleotide complementary to the pre-specified sequence on the target ssDNA molecule, and wherein said second single stranded overhang comprises a second pre-specified nucleotide sequence identical to a blocking oligonucleotide of said second probe library and is positioned immediately adjacent to the 5′ end of P.

31. The method of claim 28, for converting a target single stranded DNA molecule starting at its 3′ end, the second probe library comprises a plurality of oligonucleotide probes, each probe comprising a double stranded portion and a first and second single stranded overhang, wherein the double stranded portion comprises a 5′-3′ nucleotide sequence X′ₓ flanked by said first and second single stranded overhangs and a complementary nucleotide sequence Xₓ, wherein Xₓ comprises a pre-determined oligonucleotide code that uniquely corresponds to a set order of nucleotides A, T , G, or C, wherein the double stranded portion of the probe also comprises a type IIS restriction enzyme recognition site whose corresponding cleavage site is complete upon ligation of the probe to at least one nucleotide on the end of the target ssDNA molecule which is to be converted, wherein X comprises on its 5′ end the pre-specified sequence present on said target ssDNA molecule; wherein said first single stranded overhang comprises a nucleotide sequence complementary to the pre-specified sequence present on said target ssDNA molecule; and wherein said second single stranded overhang comprises a nucleotide at a position immediately adjacent to the nucleotide at the 3′ end of X′ₓ that is complementary to the nucleotide in the target ssDNA to be converted and further comprises at least 3 random nucleotides, and wherein said second probe library further comprises a blocking oligonucleotide comprising a 3′-5′ sequence complementary to the first single stranded overhang, wherein the 5′ end of the blocking oligonucleotide and the 5′ end of the first single stranded overhang are unphosphorylated.

32. The method of claim 29, wherein said first probe library comprises a plurality of oligonucleotide probes consisting of four distinct oligonucleotide probes, each comprising a double stranded portion and a first and second single stranded overhang, wherein the double stranded portion comprises a pre-specified nucleotide spacer sequence (P′), and a sequence complimentary to said spacer sequence (P), wherein said first single stranded overhang comprises an A, T, G, or C at a position immediately adjacent to the 3′ end of P′ and a nucleotide complementary to the pre-specified sequence on the target ssDNA molecule, and wherein said second single stranded overhang comprises a second pre-specified nucleotide sequence identical to a blocking oligonucleotide of said second probe library and is positioned immediately adjacent to the 3′ end of P.

33. The method of claim 29, wherein said second probe library comprises a plurality of oligonucleotide probes, each probe comprising a double stranded portion and a first and second single stranded overhang, wherein the double stranded portion comprises a 5′-3′ nucleotide sequence X′ₓ flanked by said first and second single stranded overhangs and a complementary nucleotide sequence Xₓ, wherein Xₓ comprises a pre-determined oligonucleotide code that uniquely corresponds to a set order of nucleotides A, T , G, or C, wherein the double stranded portion of the probe also comprises a type IIS restriction enzyme recognition site whose corresponding cleavage site is complete upon ligation of the probe to at least one nucleotide on the end of the target ssDNA molecule which is to be converted, wherein X comprises on its 3′ end the pre-specified sequence present on said target ssDNA molecule; wherein said first single stranded overhang comprises a nucleotide sequence complementary to the pre-specified sequence present on said target ssDNA molecule; and wherein said second single stranded overhang comprises a nucleotide at a position immediately adjacent to the nucleotide at the 5′ end of X′ₓ that is complementary to the nucleotide in the target ssDNA to be converted and further comprises at least 3 random nucleotides, and wherein said second probe library further comprises a blocking oligonucleotide comprising a 3′-5′ sequence complementary to the first single stranded overhang, wherein the 5′ end of the blocking oligonucleotide and the 5′ end of the first single stranded overhang are unphosphorylated.

34. The method of claim 28, wherein steps a-f are repeated more than once.

35. The method of claim 28, wherein the target ssDNA molecule is immobilized on a solid support.

36. The method of claim 28, wherein said pre-specified sequence on the target ssDNA molecule further comprises a restriction recognition site on its 3′ end.

37. The method of claim 28, wherein said pre-specified sequence on the target ssDNA molecule further comprises a restriction recognition site on its 5′ end.

38. The method of claim 28, wherein said pre-specified sequence on said target ssDNA ranges from approximately 3 nucleotides to approximately 12 nucleotides.

39. The method of claim 28, wherein said type IIS restriction enzyme site is selected from the group consisting of: AlwI, BccI, BsmA1, EarI, MlyI, PleI, BmrI, BsaI, BsmB1, FauI, HpyAV, MnlI, SapI, BbsI, BciVI, HphI, MboII, BfuaI, BspMI, SfaNI, HgaI, BbvI, EciI, FokI, BceAI, BsmFI, BtgZI, BpmI, BpuEI, BsgI, AclWI, Alw26I, Bst6I, BstMAI, Eam1104I, Ksp632I, PpsI, SchI, BfiI, Bso31I, BspTNI, Eco31I, Esp3I, FauI, SmuI, BfuI, BpiI, BpuAI, BstV2I, AsuHPI, Acc36I, LweI, AarI, BseMII, TspDTI, TspGWI, BseXI, BstV1I, Eco57I, Eco57MI, GsuI, PsrI, or MmeI site.

40. The method of claim 28, wherein said type IIS restriction enzyme site is an MmeI site.

41. The method of claim 28, wherein Xₓ comprises a first nucleic acid sequence, X_{xI}, and a second nucleic acid sequence, X_{xII}, wherein X_{xI} and X_{xII} form a binary pre-specified oligonucleotide code which uniquely corresponds to either nucleotide A, T, G, or C.

42. The method of claim 28, wherein X_{xI} and X_{xII} range from approximately 4 nucleotides to approximately 25 nucleotides each in length.

43. The method of claim 28, wherein X_{xI} and X_{xII} are each 12 nucleotides in length.

44. The method of claim 28, wherein said first overhang ranges from approximately 3 nucleotides to approximately 12 nucleotides in length.

45. The method of claim 28, wherein said second overhang ranges from approximately 3 nucleotides to approximately 12 nucleotides in length.

46. The method of claim 28, wherein said target ssDNA ranges from approximately 5 nucleotides to approximately 3,000,000 nucleotides in length.

47. The method of claim 28, wherein a plurality of target ssDNA molecules are converted at the same time.

48. The method of claim 28, wherein said conversion is performed on a sample comprising a heterogeneous mixture of target ssDNA nucleic acids.

49. The method of claim 28, wherein a polymerase enzyme is not used at any step in said method.

50. The method of claim 28, wherein said probe library has a complexity ranging from 16 to 1,048,576 distinct oligonucleotides.

51. The method of claim 28, wherein said target ssDNA molecule is derived from a mammal.

52. The method of claim 49, wherein said mammal is a human.

53. The method of claim 28, wherein said converted ssDNA molecule is sequenced at the single molecule level.

54. The method of claim 51, wherein said sequencing comprises a labeled molecular beacon.

55. The method of claim 54, wherein said labeled molecular beacon is a fluorescent molecular beacon.

56. The method of claim 55, wherein said fluorescent molecular beacon binds to an Xₓ sequence of said converted ssDNA molecule.

57. The method of claim 56, wherein said Xₓ sequence of said converted ssDNA molecule having a bound fluorescent molecular beacon is directed through a nanopore of diameter <2 nm, wherein the fluorescent molecular beacon is removed as the converted ssDNA molecule passes through said nanopore, wherein removal of said fluorescent molecular beacon produces a flash of light, wherein the order of light flashes yields the sequence of said target ssDNA sequence.
